(19) United States
(12) Patent Application Publication
(10) Pub. No.: US 2025/0344170 A1
(43) Pub. Date: Nov. 6, 2025

(54) Random Access for Estimation SSBs in AIML Systems

(71) Applicant: InterDigital Patent Holdings, Inc., Wilmington, DE (US)

(72) Inventors: Nazli Khan Beigi, Longueuil (CA); Young Woo Kwak, Woodbury, NY (US); Moon IL Lee, Melville, NY (US); Yugeswar Deenoo Narayanan Thangaraj, Chalfont, PA (US); Oumer Teyeb, Montreal (CA); Patrick Tooher, Montreal (CA); Haseeb Ur Rehman, Winnipeg (CA)

(73) Assignee: InterDigital Patent Holdings, Inc., Wilmington, DE (US)

(21) Appl. No.: 18/655,611

(22) Filed: May 6, 2024

(51) Int. Cl. H04W 56/00; H04B 17/318; H04W 24/02; H04W 74/0833

(52) U.S. Cl. CPC H04W 56/0015; H04B 17/328; H04W 24/02; H04W 74/0833

(57) ABSTRACT

A wireless transmit/receive unit (WTRU) may receive configuration information. The configuration information may include one or more of an indication of a set of estimation synchronization signal blocks (SSBs), a set of random access channel (RACH) occasions (ROs) configurations associated with the set of estimation SSBs, an indication of a set of actually transmitted SSBs, and/or a set of ROs configurations associated with the set of actually transmitted SSBs. The WTRU may receive an indication of allowed estimation SSBs including a subset of the set of estimation SSBs that are allowed to be used for a RACH transmission. The WTRU may determine a reference signal received power (RSRP) value for each estimation SSB and/or for each actually transmitted SSB. The WTRU may determine a (e.g., selected) SSB out of the set of estimation SSBs or the set of actually transmitted SSBs, for example for a RACH transmission.

### BACKGROUND

Configured reference signals (RS) (e.g., SSBs, CSI-RSs, etc.) may not all be transmitted by a network. For example, only a set of all configured RSs may be transmitted to a wireless transmit/receive unit (WTRU). The transmitted RSs may be transmission beams and/or set B beams. RSs (e.g., other RSs) that do not belong to set B beams may still be transmitted. The RSs that do not belong to Set B beams may be estimation beams and/or Set A beams. The set A beams may have longer time periods compared to set B beams.

The beams that do not belong to set B beams may be estimated, for example by the WTRU. Each beam (e.g., set B beams and estimated beams) may be associated with one or more random access channel (RACH) occasions (ROs). An RO may be used to transmit a RACH transmission.

### SUMMARY

A WTRU may receive configuration information. The configuration information may include one or more of an indication of a set of estimation synchronization signal blocks (SSBs), a set of random access channel (RACH) occasions (ROs) configurations associated with the set of estimation SSBs, an indication of a set of actually transmitted SSBs, and/or a set of ROs configurations associated with the set of actually transmitted SSBs. The WTRU may receive an indication of allowed estimation SSBs. The allowed estimation SSBs may be a subset of the set of estimation SSBs that are allowed to be used for a RACH transmission. The RACH transmission may be a physical random access channel (PRACH) transmission, for example a PRACH preamble. Transmitted SSBs may be referred to as set B and/or actually transmitted SSBs herein. Estimation SSBs may be referred to as set A herein. One or more of transmitted SSBs and/or estimation SSBs may be configured SSBs.

The WTRU may determine a reference signal received power (RSRP) value for each estimation SSB of the set of estimation SSBs. The WTRU may determine an RSRP value for each actually transmitted SSB of the set of actually transmitted SSBs. The WTRU may determine a (e.g., selected) SSB out of the set of estimation SSBs or the set of actually transmitted SSBs, for example for a RACH transmission. For example, the WTRU may determine the (e.g., selected) SSB to be an SSB out of the set of estimation SSBs when the estimation SSB has the highest RSRP value of the set of estimation SSBs and of the set of actually transmitted SSBs and/or when the estimation SSB is part of the allowed estimation SSBs. The WTRU may determine the (e.g., selected) SSB to be an SSB out of the set of actually transmitted SSBs when the actually transmitted SSB has the highest RSRP value of the set of estimation SSBs. Additionally, or alternatively, the WTRU/may determine the (e.g., selected) SSB to be an SSB out of the set of actually transmitted SSBs when the estimation SSB has the highest RSRP value of the set of estimation SSBs and of the set of actually transmitted SSBs and/or the estimation SSB is not part of the allowed estimation SSBs.

The WTRU may determine one or more ROs associated with the (e.g., selected) SSB based on the ROs configurations associated with the set of estimation SSBs or the ROs configurations associated with the set of actually transmitted SSBs. Additionally, or alternatively, the WTRU may determine one or more ROs associated with the (e.g., selected) SSB based on the subset of allowed estimation SSBs. The WTRU may transmit the RACH transmission on the one or more ROs associated with the (e.g., selected) SSB. Additionally, or alternatively, the WTRU may determine the (e.g., selected) SSB to be an SSB out of the set of estimation SSBs based on one or more of an artificial intelligence machine learning (AIML) model index, an AIML model accuracy, a periodicity of the set of SSBs, a number of SSBs in the subset of SSBs, or a priority.

The configuration information may include the artificial intelligence machine learning (AIML) model index. Additionally, or alternatively, the WTRU may determine the (e.g., selected) SSB out of the set of estimation SSBs or the set of actually transmitted SSBs using an AIML model indicated by the AIML model index. The WTRU may receive the indication of the set of actually transmitted SSBs and/or the set of ROs configurations associated with the set of actually transmitted SSBs at a first time interval. The WTRU may receive the indication of the set of actually transmitted SSBs and/or the set of ROs configurations associated with the set of actually transmitted SSBs at a second time interval. The first time interval may be greater than the second time interval.

The WTRU may determine the actually transmitted SSB out of the set of actually transmitted SSBs for the RACH transmission when the actually transmitted SSB has the highest RSRP value of the set of estimation SSBs and of the set of actually transmitted SSBs. The WTRU may determine the actually transmitted SSB out of the set of actually transmitted SSBs for the RACH transmission when an estimation SSB of the set of estimation SSBs has the highest RSRP value of the set of estimation SSBs and of the set of actually transmitted SSBs and the estimation SSB is not part of the allowed estimation SSBs.

The WTRU may determine the estimation SSB out of the set of estimation SSBs for the RACH transmission based on a comparison between a RSRP value of an actually transmitted SSB of the set of actually transmitted SSBs and a RSRP value of an estimation SSB of the set of estimation SSBs being less than a threshold. The WTRU may determine the estimation SSB out of the set of estimation SSBs for the RACH transmission based on a periodicity of the estimation SSB. The WTRU may determine the estimation SSB out of the set of estimation SSBs for the RACH transmission based on a number of actually transmitted SSBs in the set of actually transmitted SSBs being less than a threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of a subband non-overlapping full duplex (SBFD) configuration in time division duplexing (TDD) framework.

FIG. 3 is an example of SSB-RO mapping.

FIG. 4 shows an example of an RRC configuration for SSB-RO mapping.

FIG. 5 is an example of SSB-RO mapping.

FIG. 6 shows an example of two separate sets of RACH configurations.

FIG. 7 shows an example of a single set of RACH configurations.

### DETAILED DESCRIPTION

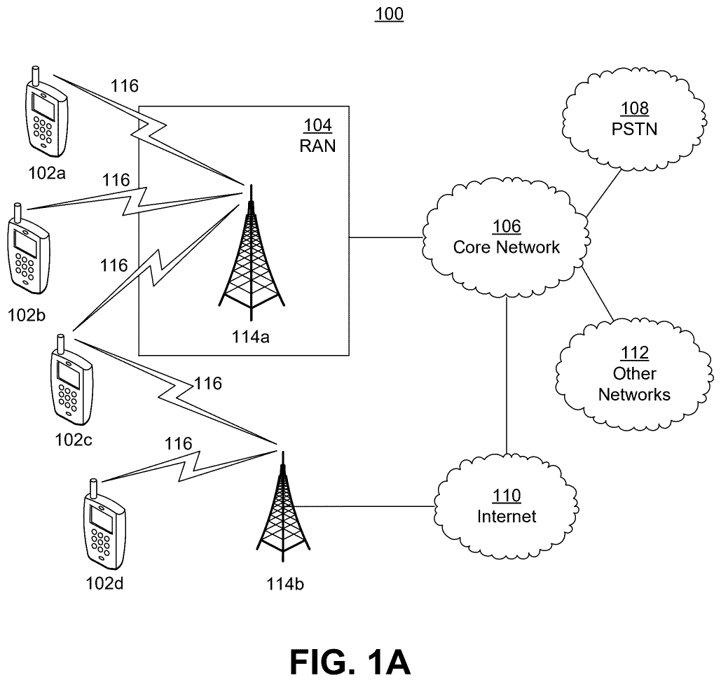

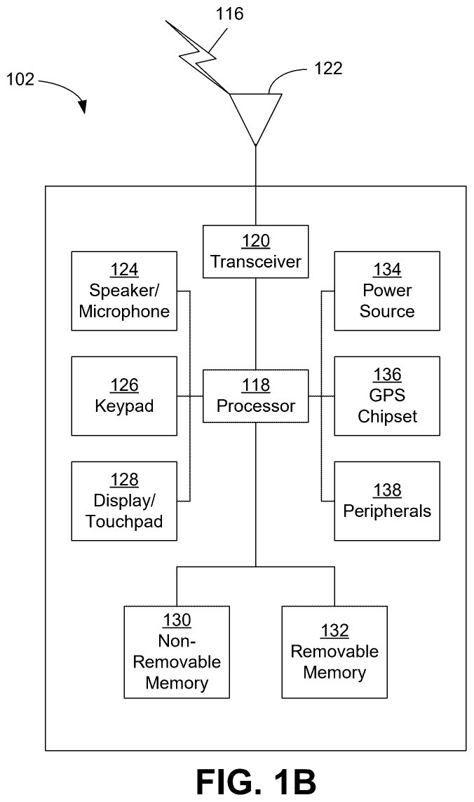

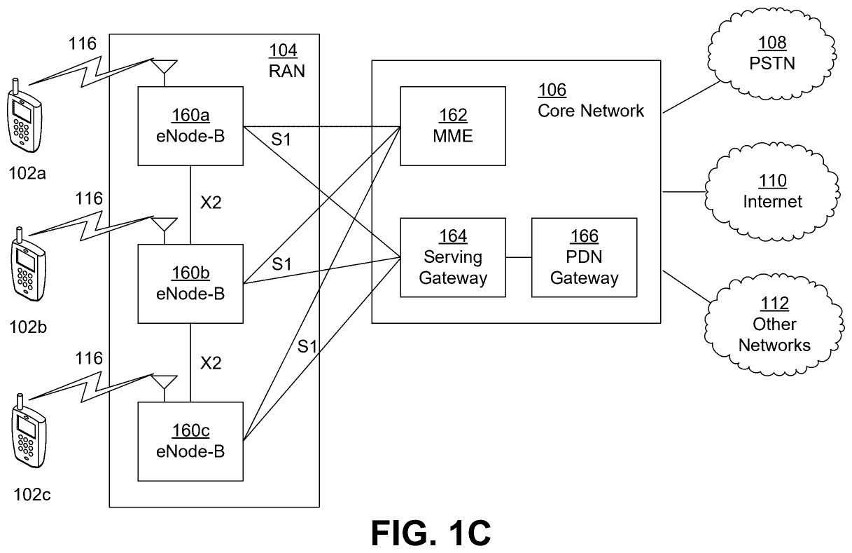

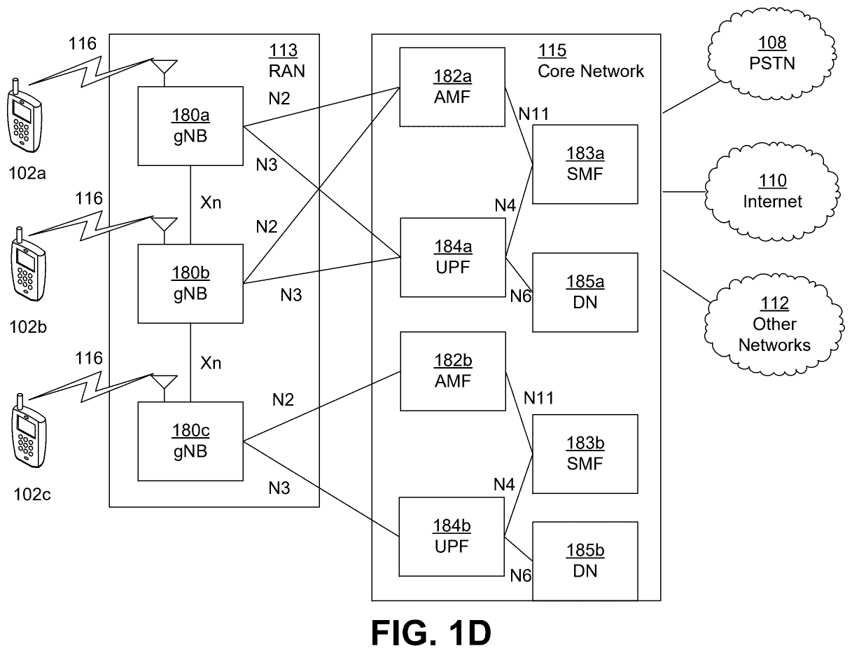

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a

NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods herein address WTRU functions in SSB-to-RB mapping, for example for estimation SSBs. Additionally, or alternatively, systems and methods herein address WTRU functions in RO selection, for example for estimation SSBs.

There may be RO selection for estimation SSB beams. A (e.g., AIML-capable) WTRU that may predict RSRP of one or more of the estimation SSB beams, for example based on measurements of transmitted SSBs. The WTRU may determine whether to perform random access for the estimation SSB beams, for example based on one or more conditions (e.g., during initial access, and/or BFR, etc).

The WTRU may receive a set of configurations, for example on RACH configurations, for transmitted and/or estimation SSB beams (e.g., within an SSB burst) via SIB1 (or RRC). A configurations may include one or more of a set of transmitted SSBs via ssb-PositionsInBurst, a set B transmitted SSBs via ssb-PositionsInBurst-SetB, a set of estimation SSBs (e.g., or set A) via ssb-PositionsInBurst-SetA, a set A transmission periodicity (e.g., explicitly or implicitly based on set B and SIB1 periodicity), an AIML model index(es) to be used for SSB predictions, a first set of RACH occasion (RO) time/frequency configurations associated with transmitted set B SSBs, and/or a second set of RACH occasion (RO) time/frequency configurations associated with estimation SSBs. Set B may for example be the same as a set of transmitted SSBs in SSB bursts with only including set B SSB beams. The second set of RACH occasion (RO) time/frequency configurations may include an absolute set of configurations and/or may include a relative set of time/frequency configurations (e.g., relative to the first set of time/frequency configurations). Transmitted SSBs may be referred to as set B and/or actually transmitted SSBs herein. Estimation SSBs may be referred to as set A herein. One or more of transmitted SSBs and/or estimation SSBs may be configured SSBs.

There may be a subset of allowed estimation SSBs, for example for a PRACH transmission. The WTRU may receive an indication of a subset of SSBs from the configured set of estimation SSBs (e.g., via SIB1) (e.g., SSB-subset-Est), for example for which the WTRU may (e.g., is allowed to) transmit PRACH preambles (e.g., in the associated ROs). There may be traffic control and/or power saving, for example as a gNB may not activate and/or use all UL beams.

The WTRU may receive and/or measure RSRP for one or more of the (e.g., configured) transmitted SSBs. The WTRU may predict RSRP for one or more of the estimation SSBs. The WTRU may determine that the best beam among transmitted and/or estimation SSBs (e.g., with highest measured or predicted RSRP) is one of the estimation beams.

There may be one or more conditions on selecting an estimation SSB for RACH. The WTRU may determine whether to select the predicted (e.g., best) estimation SSB for PRACH transmission, for example if the predicted (e.g., best) SSB in within the indicated subset of allowed estimation SSBs and/or based on one or more conditions (e.g., satisfied condition(s)). The one or more conditions may include one or more of an AIML model index, an AIML model performance accuracy, a set A periodicity, a number of transmitted SSBs, and/or a prioritization. Prioritization may be based on a RA triggered event. The prioritization based on a RA triggered event may include a time sensitive event (e.g., BFR, SR, initial access, and/or PDCCH order, etc.

If the predicted (e.g., best) estimation SSB is within the indicated subset of allowed estimation SSBs and/or one or more conditions are satisfied for example, the WTRU may determine the RO associated with the predicted (e.g., best) estimation SSB. SSB-RO mapping may be determined. The WTRU may determine ROs (e.g., based on configured second set of RO configurations) and SSB-RO mapping for estimation SSBs based on the configured estimation SSBs and/or the received indication on the subset of allowed estimation SSBs. For example, the WTRU may determine SSB-RO mapping (e.g., only) for the ROs that are associated with the indicated subset of allowed estimation SSBs. If the predicted (e.g., best) estimation SSB is not within the indicated subset of allowed estimation SSBs and/or one or more conditions are not satisfied, the WTRU may select the best transmitted SSB (e.g., with highest measured RSRP) and/or determine the RO associated with the (e.g., best) transmitted SSB. The WTRU may transmit PRACH on the determined RO.

Herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Herein, the terms prediction and estimation may be used interchangeably. Herein, the terms candidate cell, neighbor cell, and target cell may be used interchangeably. Herein, the terms source cell, current cell, and serving cell may be used interchangeably.

Artificial intelligence may refer to the behavior exhibited by machines. Such behavior may include mimicking cognitive functions to sense, reason, adapt, and/or act. Machine learning may refer to type of algorithms that solve a problem based on learning through experience (e.g., data), for example without explicitly being programmed (e.g., with a configured set of rules). Machine learning may be considered as a subset of AI. Different machine learning paradigms may be envisioned based on the nature of data and/or feedback available to the learning algorithm. For example, a supervised learning approach may involve learning a function that maps input to an output based on a labeled training example. Each training example may include a pair including input and the corresponding output. For example, unsupervised learning approach may involve detecting patterns in the data with no pre-existing labels. For example, reinforcement learning approach may involve performing sequence of actions in an environment to maximize the cumulative reward.

Systems and methods may apply machine learning algorithms using a combination and/or interpolation of the approaches as herein. For example, semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may refer to a class of machine learning algorithms that employ artificial neural networks (e.g., DNNs), for example which were loosely inspired from biological systems. The Deep Neural Networks (DNNs) are a special class of machine learning models inspired by human brain wherein the input is linearly transformed and pass-through non-linear activation function multiple times. DNNs may include multiple layers, for example where each layer may include linear transformation and a given non-linear activation functions. The DNNs can be trained using the training data via back-propagation algorithm. DNNs have shown state-of-the-art performance in variety of domains (e.g., speech, vision, and/or natural language, etc.) and/or for various machine learning settings supervised, un-supervised, and/or semi-supervised.

The term AIML based methods/processing may refer to realization of behaviors and/or conformance to requirements by learning based on data, for example without explicit configuration of sequence of steps of actions. Methods may enable learning complex behaviors which might be difficult to specify and/or implement, for example when using legacy methods. AIML model may be referred to herein as an implementation of an AIML based method. The AIML based method may include model parameters and/or model structure. For example, a DNN-based AIML model may include the model parameters (e.g., weights and/or biases) and/or the model structure (e.g., the types and/or sizes of each layer of the deep neural network such as dense layers, and/or convolutional layers, etc.)

A WTRU may transmit and/or receive a physical channel and/or reference signal, for example according to at least one spatial domain filter. The term “beam” may be used to refer to a spatial domain filter. The WTRU may transmit a physical channel and/or signal using the same spatial domain filter as the spatial domain filter used for receiving an RS (e.g., CSI-RS) and/or a SS block. The WTRU transmission may be referred to as target. The received RS and/or SS block may be referred to as reference or source. For example, the WTRU may be said to transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and second transmissions may be referred to as target and reference (e.g., or source), respectively. For example, the WTRU may be said to transmit the first (e.g., target) physical channel and/or signal according to a spatial relation with a reference to the second (e.g., reference) physical channel and/or signal. A spatial relation may be one or more of implicit, configured by RRC, signaled by MAC CE, and/or signaled/configured by DCI. For example, a WTRU may implicitly transmit PUSCH and/or DM-RS of PUSCH according to the same spatial domain filter as an SRS indicated by an SRI indicated in DCI and/or configured by RRC. In another example, a spatial relation may be configured by RRC for an SRS resource indicator (SRI) and/or signaled by MAC CE for a PUCCH. The spatial relation may be referred to as a beam indication.

The WTRU may receive a first (e.g., target) downlink channel and/or signal according to the same spatial domain filter and/or spatial reception parameter as a second (e.g., reference) downlink channel and/or signal. For example, an association may exist between a physical channel, for example such as PDCCH or PDSCH, and a respective DM-RS. At least when the first and second signals are reference signals for example, the association may exist when the WTRU is configured with a quasi-colocation (QCL) assumption type D between corresponding antenna ports. The association may be configured as a TCI (transmission configuration indicator) state. A WTRU may be indicated an association between a CSI-RS and/or SS block and a DM-RS, for example by an index to a set of TCI states configured by RRC and/or signaled by MAC CE. The indication may be referred to as a beam indication.

A beam resource may include one or more of a TCI state, CSI-RS, a DL RS, a SSB for downlink, an SRS resource, an UL RS, and/or TCI state for uplink. A beam resource may be identified by a beam indication.

Herein a TRP (e.g., transmission and reception point) may be interchangeably used with one or more of TP (transmission point), RP (reception point), RRH (radio remote head), DA (distributed antenna), BS (base station), a sector (of a BS), and/or a cell (e.g., a geographical cell area served by a BS). Herein, Multi-TRP may be interchangeably used with one or more of MTRP, M-TRP, and/or multiple TRPs.

A WTRU may report a subset of channel state information (CSI) components. The CSI components may correspond to one or more of a CSI-RS resource indicator (CRI), a SSB resource indicator (SSBRI), an indication of a panel used for reception at the WTRU (e.g., a panel identity or group identity), measurements (e.g., L1-RSRP, L1-SINR) taken from SSB and/or CSI-RS (e.g. cri-RSRP, cri-SINR, ssb-Index-RSRP, ssb-Index-SINR), and/or other channel state information (e.g., one or more of rank indicator (RI), channel quality indicator (CQI), precoding matrix indicator (PMI), Layer Index (LI), and/or the like).

A WTRU may receive a synchronization signal/physical broadcast channel (SS/PBCH) block. The SS/PBCH block (SSB) may include one or more of a primary synchronization signal (PSS), secondary synchronization signal (SSS), and physical broadcast channel (PBCH). The WTRU may monitor, receive, and/or attempt to decode an SSB, for example during one or more of initial access, initial synchronization, radio link monitoring (RLM), cell search, cell switching, and/or etc. A WTRU may measure and/or report the channel state information (CSI). The CSI for each connection mode may include or be configured with one or more of CSI report configuration; CSI-RS resource set; and/or non-zero power (NZP) CSI-RS resources. A CSI report configuration may include one or more of CSI report quantity (e.g., channel quality indicator (CQI), rank indicator (RI), precoding matrix indicator (PMI), CSI-RS resource indicator (CRI), layer indicator (LI), etc.), CSI report type (e.g., aperiodic, semi persistent, periodic), CSI report codebook configuration (e.g., Type I, Type II, Type II port selection, etc.), and/or CSI report frequency. A CSI-RS resource set may include one or more CSI resource settings. CSI resource settings may include one or more of NZP-CSI-RS resource for channel measurement; NZP-CSI-RS resource for interference measurement; and/or CSI-IM resource for interference measurement. NZP CSI-RS resources may include one or more of NZP CSI-RS resource ID; periodicity and offset; QCL info and TCI-state; and/or resource mapping (e.g., number of ports, density, CDM type, etc.)

A WTRU may indicate, determine, and/or be configured with one or more reference signals. The WTRU may monitor, receive, and/or measure one or more parameters, for example based on the respective reference signals. The following parameters are non-limiting examples of the parameters that may be included in reference signal(s) measurements. One or more of these parameters may be included. Other parameters may be included. For example, parameters may include one or more of SS reference signal received power (SS-RSRP); CSI- RSRP; SS signal-to-noise and interference ratio (SS-SINR); CSI-SINR; received signal strength indicator (RSSI); cross-layer interference received signal strength indicator (CLI-RSSI); sounding reverence signals RSRP (SRS-RSRP); secondary synchronization signal reference signal received quality (SS-RSRQ); and/or CSI reference signal received quality (CSI-RSRQ).

SS reference signal received power (SS-RSRP) may be measured, for example based on the synchronization signals (e.g., demodulation reference signal (DMRS) in PBCH and/or SSS). SS-RSRP may include a linear average over the power contribution of the resource elements (RE) that carry the respective synchronization signal. In measuring the RSRP for example, power scaling for the reference signals may be utilized. The measurement may be made based on CSI reference signals in addition to, or in the alternative to, the synchronization signals, for example if SS-RSRP is used for L1-RSRP.

CSI-RSRP may be measured, for example based on the linear average over the power contribution of the resource elements (RE) that carry the respective CSI-RS. The CSI-RSRP measurement may be configured within measurement resources for the configured CSI-RS occasions.

SS signal-to-noise and interference ratio (SS-SINR) may be measured based on the synchronization signals (e.g., DMRS in PBCH and/or SSS). SS-SINR may include the linear average over the power contribution of the resource elements (RE) that carry the respective synchronization signal divided by the linear average of the noise and interference power contribution. The noise and/or interference power measurement may be made based on resources configured by higher layers, for example if SS-SINR is used for L1-SINR.

CSI-SINR may be measured based on the linear average over the power contribution of the resource elements (RE) that carry the respective CSI-RS divided by the linear average of the noise and interference power contribution. The noise and/or interference power measurement may be made based on resources configured by higher layers, for example if CSI-SINR is used for L1-SINR. In some examples (e.g., otherwise), the noise and interference power may be measured based on the resources that carry the respective CSI-RS.

Received signal strength indicator (RSSI) may be measured, for example based on the average of the total power contribution in configured OFDM symbols and/or bandwidth. The power contribution may be received from different resources. For example, the power contribution may be received from one or more of co-channel serving and non-serving cells, adjacent channel interference, thermal noise, and/or etc.

Cross-Layer interference received signal strength indicator (CLI-RSSI) may be measured, for example based on the average of the total power contribution in configured OFDM symbols of the configured time and/or frequency resources. The power contribution may be received from different resources. For example, the power contribution may be received from one or more of cross-layer interference, co-channel serving and non-serving cells, adjacent channel interference, thermal noise, and/or etc.

Sounding reference signals RSRP (SRS-RSRP) may be measured based on the linear average over the power contribution of the resource elements (RE) that carry the respective SRS.

Secondary synchronization signal reference signal received quality (SS-RSRQ) may be measured, for example based on measurements on the reference signal received power (SS-RSRP) and/or received signal strength (RSSI). The SS-RSRQ may be calculated as a ratio of N×SS-RSRP and NR carrier RSSI. N may be determined based on the number of resource blocks that are in the corresponding NR carrier RSSI measurement bandwidth. Additionally, or alternatively, the measurements to be used in the numerator and/or denominator may be over the same set of resource blocks.

CSI reference signal received quality (CSI-RSRQ) may be measured, for example based on measurements on the reference signal received power (CSI-RSRP) and/or received signal strength (RSSI). The SS-RSRQ may be calculated as the ratio of N×CSI-RSRP and CSIRSSI. N may be determined based on the number of resource blocks that are in the corresponding CSI-RSSI measurement bandwidth. Additionally, or alternatively, the measurements to be used in the numerator and denominator may be over the same set of resource blocks.

A CSI report configuration (e.g., CSI-ReportConfigurations) may be associated with a (e.g., single) BWP (e.g., indicated by BWP-Id), for example where one or more parameters are configured. The one or more parameters may include one or more of a CSI-RS resource and/or CSI-RS resource sets for channel and interference measurement, a CSI-RS report configuration type, a CSI-RS transmission periodicity for periodic and/or semi-persistent CSI reports, a CSI-RS transmission slot offset for periodic, semi-persistent and/or aperiodic CSI reports, a CSI-RS transmission slot offset list for semi-persistent and aperiodic CSI reports, a time restriction for channel and interference measurements, a report frequency band configuration (e.g., wideband/subband CQI, and/or PMI, and so forth), a threshold and/or mode of calculations for the reporting quantities (e.g., CQI, RSRP, SINR, LI, and/or RI, etc.), a codebook configuration, a group based beam reporting, a CQI table, a subband size, a non-PMI port indication, and/or a port index, etc. A CSI-RS report configuration type may include one or more of periodic, semi-persistent, and/or aperiodic.

A CSI-RS Resource Set (e.g., NZP-CSI-RS-ResourceSet) may include one or more CSI-RS resources (e.g., NZP-CSI-RS-Resource and CSI-ResourceConfig). A WTRU may be configured, in a CSI-RS resource, with one or more of a CSI-RS periodicity and/or slot offset for periodic and/or semi-persistent CSI-RS resources, a CSI resource mapping, a bandwidth part to which the configured CSI-RS is allocated, and/or a reference to the TCI-State. The reference to the TCI-state may include the QCL source RS(s) and/or the corresponding QCL type(s). The CSI-RS resource mapping may include (e.g., define) one or more of the number of CSI-RS ports, density, CDM-type, OFDM symbol, and/or subcarrier occupancy.

There may be a RS resource set configuration. A WTRU may be configured with one or more RS resource sets. The RS resource set configuration may include one or more of a RS resource set ID, one or more RS resources for the RS resource set, repetition (e.g., on or off), an aperiodic triggering offset (e.g., one of 0-6 slots), and/or a TRS info (e.g., true or not).

A WTRU may be configured with one or more RS resources. The RS resource configuration may include one or more of a RS resource ID, a resource mapping (e.g., REs in a PRB), a power control offset (e.g., one value of −8, . . . , 15), a power control offset with SS (e.g., −3 dB, 0 dB, 3 dB, 6 Db), a scrambling ID, a periodicity and/or offset, and/or a QCL information (e.g., based on a TCI state).

There may be a property of a grant and/or assignment. A property of a grant or assignment may include one or more of a frequency allocation; an aspect of time allocation (e.g., duration), a priority, a modulation and coding scheme, a transport block size, a number of spatial layers, a number of transport blocks, a TCI state, a CRI, a SRI, a number of repetitions, whether the repetition scheme is Type A or Type B, whether the grant is a configured grant type 1, type 2, and/or a dynamic grant, whether the assignment is a dynamic assignment and/or a semi-persistent scheduling (e.g., configured) assignment, a configured grant index and/or a semi-persistent assignment index, a periodicity of a configured grant and/or assignment, a channel access priority class (CAPC), and/or a parameter provided in a DCI, by MAC, and/or by RRC for the scheduling the grant and/or assignment.

An indication by DCI may include one or more of an explicit indication and/or an implicit indication. The explicit indication may be by a DCI field and/or by RNTI, for example used to mask and/or scramble the CRC of the DCI. The implicit indication may be by a property, for example including one or more of a DCI format, DCI size, Coreset or search space, Aggregation Level, and/or a first resource element of the received DCI (e.g., index of first Control Channel Element). Mapping between the property and the value may be signaled by RRC and/or MAC. Receiving and/or monitoring for a DCI with or using an RNTI may mean that the CRC of the DCI is masked and/or scrambled with the RNTI.

There may be properties of a scheduling request (SR). The WTRU may use a SR, for example for requesting UL-SCH resources for new transmission. The WTRU may use SR for sending one or more requests, indications, and/or reports, for example to a gNB. The WTRU may be configured with zero, one, or more SR configurations. An SR configuration may include a set of PUCCH resources, for example for SR across different BWPs and/or cells. In an example, the WTRU may be configured with at most one PUCCH resource for SR per BWP, for example for a logical channel or for secondary cell (SCell) beam failure recovery and/or for consistent LBT failure recovery. In another example, the WTRU may be configured with for example up to two PUCCH resources for SR per BWP, for example for beam failure recovery of BFD-RS set(s) of a serving cell. For example, each SR configuration may correspond to one or more logical channels, SCell beam failure recovery, consistent LBT failure recovery, and/or beam failure recovery of a BFD-RS set, etc. In an example, each logical channel, SCell beam failure recovery, beam failure recovery of a BFD-RS set and consistent LBT failure recovery, may be mapped to zero or one SR configuration, which may be configured via RRC.

Herein a signal may be interchangeably used with one or more of a sounding reference signal (SRS), channel state information-reference signal (CSI-RS), a demodulation reference signal (DM-RS), a phase tracking reference signal (PT-RS), and/or a synchronization signal block (SSB). Herein a channel may be interchangeably used with one or more of a physical downlink control channel (PDCCH), a physical downlink shared channel (PDSCH), a physical uplink control channel (PUCCH), a physical uplink shared channel (PUSCH), and/or a physical random access channel (PRACH), etc. Herein a signal, channel, and message (e.g., as in DL or UL signal, channel, and message) may be used interchangeably. Herein RS may be interchangeably used with one or more of RS resource, RS resource set, and/or RS port and RS port group.

Herein RS may be interchangeably used with one or more of SSB, CSI-RS, SRS, and DM-RS, TRS, PRS, and/or PTRS. Herein time instance, slot, symbol, and subframe may be used interchangeably. Herein, the terms SSB, SS/PBCH block, PSS, SSS, PBCH, and MIB may be used interchangeably. Herein, SSB, SSB beam, and SSB index may be used interchangeably. The proposed solutions estimation and/or prediction may be used for transmissions and/or receptions belonging to one or more of single or multiple cells, inter-cell, intra-cell, and/or single or multiple TRPs. Herein CSI reporting may be interchangeably used with CSI measurement, and/or beam reporting and/or beam measurement. Herein a RS resource set may be interchangeably used with a beam group. Herein, the terms prediction, estimation, calculation, evaluation, and determination may be used interchangeably.

Herein, RSRP may be used interchangeably with SS-RSRP, CSI-RSRP, SRS-RSRP, RSRP measured based on DMRS in PBCH, RSRP measured based on DMRS in PDCCH, RSRP measured based on DMRS in PDSCH, RSRP measured based on DMRS in PUCCH, RSRP measured based on DMRS in PUSCH, etc.

Systems and methods as herein may improve performance and/or complexity for beam management, including for example one or more of beam prediction in time, spatial domain for overhead and latency reduction, and/or beam selection accuracy improvement, etc.

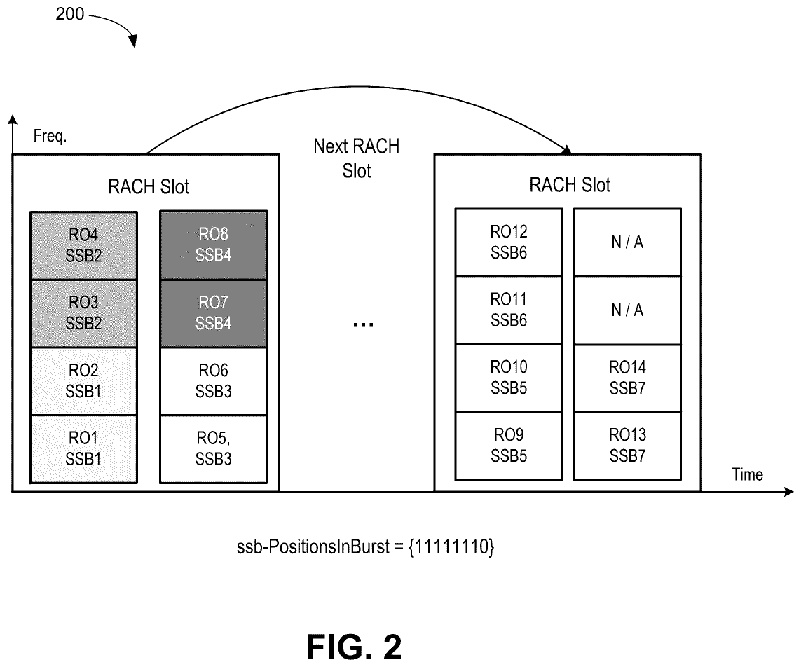

Artificial Intelligence (AI)/Machine Learning (ML) may be used for beam management. For example, a WTRU may predict beams that are not transmitted frequently (e.g., set A beams). The WTRU may predict the beams based on measured beams from the set B beams. The beams that are not transmitted frequently may be estimation beams and/or set A beams. Transmitted SSBs may be indicated via ssb-PositionsInBurst in SIB1 and/or in ServingCellConfigCommon. A WTRU may perform SSB-RO mapping (e.g., accordingly). An example SSB-RO mapping is shown in FIG. 2.

FIG. 2 is an example of a subband non-overlapping full duplex (SBFD) configuration in time division duplexing (TDD) framework. The example of FIG. 2 shows a system with 8 SSBs, where S=7 SSBs (e.g., SSB1, SSB2, . . . , SSB7) are transmitted. In this example, four consecutive SSBs are frequency division multiplexed (M=4) and each SSB is mapped to N=2 ROs.

Sets of RACH slots are shown over time. As first set of RACH slots may include RO1 (e.g., associated with SSB1), RO2 (e.g., associated with SSB1), RO3 (e.g., associated with SSB2), RO4 (e.g., associated with SSB2), RO5 (e.g., associated with SSB3), RO6 (e.g., associated with SSB3), RO7 (e.g., associated with SSB4), and/or RO8 (e.g., associated with SSB4). Transmitted SSBs (e.g., SSB1, SSB2, and SSB3) may be indicated via ssb-PositionsInBurst={10010010}). A “1” may indicate that the corresponding SSB (e.g., SSB1, SSB2, and SSB3) are transmitted. A “0” may indicate that the corresponding SSB (e.g., SSB4) is not transmitted. A second set of RACH slots (e.g. at a second time) may may include RO9 (e.g., associated with SSB5), RO10 (e.g., associated with SSB5), RO11 (e.g., associated with SSB6), RO12 (e.g., associated with SSB6), RO13 (e.g., associated with SSB7), and/or RO14 (e.g., associated with SSB7). One or more ROs may not be used (e.g., transmitted), for example as indicated by “N/A’ in FIG. 2.

Systems and methods may address determining the resource allocations, mappings, and/or scheduling in association with SSBs. Associations in non-AIML systems may be (e.g., mostly) based on transmitted SSBs. Systems and methods for resource mappings, resource determinations, and so forth, for example for estimation SSBs and/or set A SSB beams are provided. The estimation SSB beams may not be transmitted, for example in a corresponding SSB burst. The SSB-to-RO mapping, and/or RO selection for RACH procedures and/or random access preamble transmission are provided herein. Systems and methods may be applied to one or more of contention-based random access (CBRA), contention-free random access (CFRA), and/or a Type-1 random access procedure (e.g., 4-Step RACH), and/or a Type-2 random access procedure (e.g., 2-Step RACH), etc.

Systems and methods on resource mappings, resource determinations, monitoring occasions, etc., for example based on association with estimation SSBs, may be applied to use cases and scenarios other than random access procedures. There may be one or more PDCCH monitoring occasions. For example, the WTRU may use the systems and methods herein for determining the mapping between one or more estimation SSBs and PDCCH monitoring occasion(s). In an example, the mapping between estimation SSBs and PDCCH monitoring occasion(s) may be used for one or more of system information (SI) message acquisition, multicast and broadcast services (MBS) traffic channel (MTCH) acquisition, and/or MBS control channel (MCCH) scheduling. There may be SI message acquisition. The WTRU may use the determined mapping for PDCCH monitoring occasion(s) associated to one or more estimation SSBs for SI message acquisition (e.g., in SI-window), for example corresponding to one or more estimation SSBs. There may be MBS traffic channel (MTCH) acquisition. The WTRU may use the determined mapping for PDCCH monitoring occasion(s) associated to one or more estimation SSBs for MTCH message acquisition (e.g., in a MTCH mapping window), for example corresponding to one or more estimation SSBs. There may be MCCH scheduling. The WTRU may use the determined mapping for PDCCH monitoring occasion(s) associated to one or more estimation SSBs for MCCH message acquisition (e.g., in a MCCH transmission window), for example corresponding to one or more estimation SSBs.

There may be one or more PUSCH occasions. The WTRU may use the systems and methods herein for determining the mapping between one or more estimation SSBs and PUSCH occasion(s). For example, the mapping between estimation SSBs and PUSCH occasion(s) may be used for one or more of a Type-2 random access procedure (2-step RACH), and/or PUSCH scheduled by a random access response (RAR) UL grant, etc. For example, the WTRU may use the determined mapping for PUSCH occasions associated with one or more estimation SSBs for Msg-A PUSCH transmission in Type-2 random-access procedure. In another example, the WTRU may use the determined mapping for PUSCH occasions associated with one or more estimation SSBs for PUSCH transmission scheduled by RAR UL grant.

There may be set A and/or set B beams. There may be a configuration of measurement and estimation sets. A WTRU may be configured with one or more sets of reference signal (RS) resources and/or beams (or beam-pairs). Each RS resource or beam or beam-pair may be associated with a transmission from a beam of specific beam parameters (e.g., beam direction and beamwidth). The WTRU may be configured with the associated beams and/or RS resources and the beam parameters.

For example, a WTRU may be configured with a first set of RS resources, beams, and/or beam-pairs that, for example may cover the entire RS resource-space and/or beam-space or beam-pair-space. The WTRU may determine or select a set A and/or a set B, for example such that a union of set A and set B covers the entire RS-resource-space and/or beam-space or beam-pair-space. In an example, set A and set B may be mutually exclusive. A set B may include RS resources, for example on which the WTRU may perform measurements to obtain one or more of a direct measurement value for a first set of beams and/or beam-pairs (e.g., one-to-one mapping between an RS resource and a beam or beam-pair), and/or an estimated measurement value for a second set of beams and/or beam-pairs (e.g., many-to-one mapping between RS resources and a beam or beam-pair and possibly using Al/ML estimation model).

There may be set A and/or set B requirements. A WTRU may be configured with one or more sets of RS resources, for example associated to each beam. A WTRU may be configured with a first beam associated with two sets of RSs. A first set may include a (e.g., single) RS resource and/or a second set may include multiple RS resources. A WTRU may determine one or more measurements associated with the beam, for example via direct measurements of the RS resources in a first set and/or via estimation obtained from measurements of the RS resources in a second set. A WTRU may determine a measurement set of RS resources. The WTRU may determine a measurement set of RS resources (e.g., a set B), such that for every beam for which the WTRU determines to obtain measurements (e.g., either directly or via estimation), the set B may include one or more of the two sets of RS resources associated to the beam.

Herein a set B may be interchangeably used with a set of RS resource sets, beams, beam-pairs, beam RS resources, transmitted beams, actually transmitted beams, and/or RS resources and a beam pattern. Herein a set A may be interchangeably used with a set of RS resource sets, beams, beam-pairs, estimation beams, beam RS resources, RS resources, and/or a beam pattern.

A WTRU may be (pre)configured with a (e.g., maximum) number of RSs and/or SSBs (e.g., within an SSB burst) in a cell. The (e.g., maximum) number of SSBs and/or RSs may be explicitly configured for the WTRU (e.g., via MIB, SIB, RRC, MAC-CE, DCI, etc.). Alternatively, or additionally, the (e.g., maximum) number of SSBs and/or RSs may be implicitly indicated to the WTRU, for example based on the used frequency range. For example if the WTRU is operating in a first frequency range (e.g., FR1), the WTRU may determine the (e.g., maximum) number of the SSBs and/or RSs to be a first value (e.g., maximum eight SSBs and/or RSs). If for example the WTRU is operating in a second frequency range (e.g., FR2), the WTRU may determine the maximum number of the SSBs and/or RSs (e.g., within a SSB burst) to be a second value (e.g., maximum 64 SSBs and/or RSs), etc.

A WTRU may detect one or more SSBs and/or RSs (e.g., within an SSB burst), for example during one or more of initial access, cell (re) selection, beam measurement, and/or beam management, etc. Considering the maximum number of SSBs and/or RSs, only a subset of SSBs and/or RSs may be one or more of planned, configured, required, expected, and/or designed to be used (e.g., in a cell). The set of the planned SSBs and/or RSs may be a set of SSBs and/or RSs that, for example may cover the entire SSB and/or RSs resource-space or beam-space. In an example, the number of planned SSBs and/or RSs may be lower than or equal to the maximum number of SSBs and/or RSs, that for example is determined at the network based on one or more of the SSBs and/or RSs coverage space, and/or correlation of the beams, etc. The WTRU may be provided and/or configured with the number of planned SSBs, RSs, and/or the corresponding SSB and/or RS beam indexes.

The WTRU may receive, be provided, and/or be configured with the information on actually transmitted RSs and/or SSBs, for example within an SSB burst. The information may include the number of actually transmitted SSB and/or RSs beams, the SSB and/or RSs indexes corresponding to the actually transmitted SSB beams, and so forth. The WTRU may consider the set of actually transmitted SSBs and/or RSs as set B, where for example set B may be a subset of configured set A. Alternatively, or additionally, the WTRU may determine, be provided, and/or be configured with a set of skipped SSBs and/or RSs which, for example may not be actually being transmitted in the corresponding SSB burst and/or RS transmission time window. The WTRU may use the set of transmission beams (e.g., set B) to estimate and/or predict the beams that are not transmitted. The WTRU may consider the set of estimation SSBs and/or RSs as set A.

The WTRU may be (pre) configured with one or more first configuration information on the transmission on one or more set B beams. The first configuration information may include time and frequency resources, time period, frequency hopping, and so forth, for example for the transmission of the SSBs/RSs in the corresponding set B. The WTRU may additionally, or alternatively, be configured with a second set of configuration information regarding the transmission of set A beams. For example, the WTRU may receive configurations regarding the instances where (e.g., all) transmission and estimation SSBs and/or RSs associated with set A and/or set B will be transmitted. The second configuration information may include one or more of time and frequency resources, time period, frequency hopping, and so forth, for example for the transmission of the SSBs/RSs in the corresponding set A. The second time period corresponding to transmission of set A beams may be longer than the first time period corresponding to transmission of set B beams. The WTRU may receive the first and/or second configuration information, for example via one or more of MIB, SIB, RRC, MAC-CE, and/or DCI, etc.

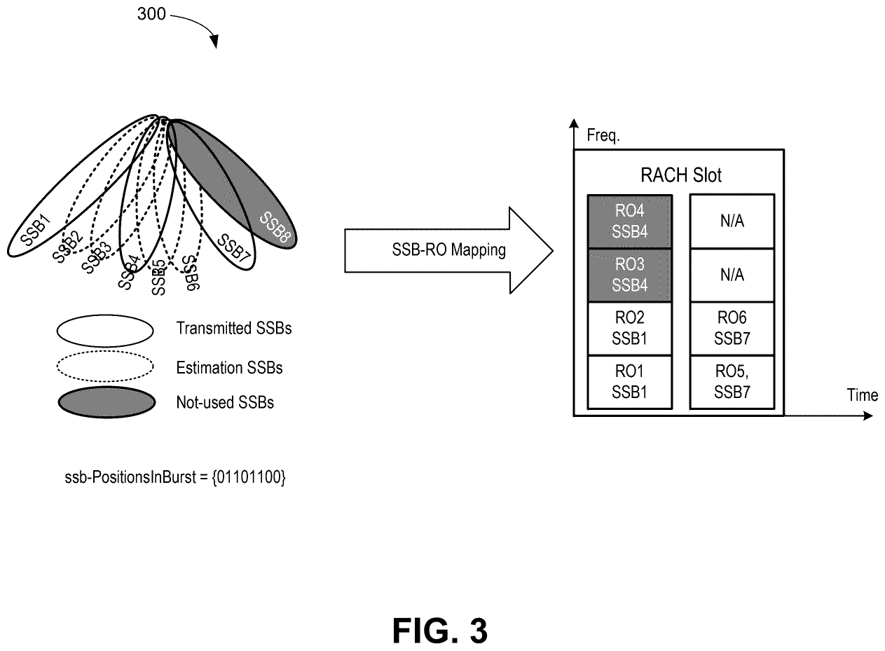

Estimation SSBs may not be transmitted as frequently as set B (e.g., transmitted) SSBs, for example in AIML systems. The estimation SSBs may be selected via AIML-capable WTRUs, for example based on predictions (e.g., predicted RSRP). FIG. 3 is an example 300 of SSB-RO mapping. The SSB-RO mapping may be in an AIML system, for example with transmitted SSBs and/or estimation SSBs. FIG. 3 shows eight total SSBs. SSB1, SSB4, and SSB7 are transmitted SSBs. The network may send an indication of the transmitted SSBs to the WTRU. The transmitted SSBs (e.g., SSB1, SSB4, and SSB7) may be indicated via ssb-PositionsInBurst={10010010}). A “1” may indicate that the corresponding SSB (e.g., SSB1, SSB4, and SSB7) are transmitted. A “0” may indicate that the corresponding SSB (e.g., SSB2, SSB3, SSB5, and SSB8) are not transmitted. SSB2, SSB3, SSB5, and SSB6 are estimation SSBs. The estimation SSBs (e.g., SSB2, SSB3, SSB5, and SSB6) may be indicated via ssb-PositionsInBurst-SetA={01101100}). SSB 8 is not used for SSB transmission. The WTRU may map SSB-RO (e.g., only) for transmitted beams for example. The WTRU and/or network may map SSB1 to RO1 and/or RO2. The WTRU and/or network may map SSB4 to RO3 and/or RO4. The WTRU and/or network may map SSB7 to RO5 and/or RO6. A WTRU (e.g., an AIML capable WTRU) may map SSB-RO for estimation SSBs.

Referring again to FIG. 3, a system with skipped SSBs is shown. The transmitted beams (e.g., SSBs) may be set B beams (e.g., SSBs). The transmitted beams may include SSB1, SSB4, and SSB7. The estimation beams (e.g., SSBs) may be set A beams (e.g., SSBs). The estimation beams may include SSB2, SSB3, SSB5, and SSB6. SSB8 may not be used (e.g., by a gNB) and/or may not belong to set A nor set B.

There may be a RACH configuration. A WTRU may receive, identify, and/or be configured with the time domain resource allocations for one or more (e.g., consecutive) RACH occasions (RO), for example based on the higher-layer parameter (e.g., via prach-ConfigurationIndex, msgA-PRACH-ConfigurationIndex) if configured, etc. The parameters may denote the PRACH configuration index, for example corresponding to one or more tables that may include random access parameters. The WTRU may be configured with one or more parameters. The one or more parameters may include one or more of a preamble format, a frame number, a subframe number, a slot number, a starting symbol, a number of PRACH slots, a number of time-domain PRACH occasions, and/or a PRACH duration.

The WTRU may be configured with a preamble format. For example, the WTRU may be configured with preamble format that may refer to one of the possible formats. The possible formats may include one or more of A1, A2, A3, B1, A1/B1, A2/B2, A3/B3, B4, C0, and/or C2. The preamble format may identify one or more of the corresponding cyclic prefix (CP) duration, sequence part duration, and/or guard time duration (e.g., if applicable), etc.

The WTRU may be configured with one or more of a frame number, subframe number, and/or slot number. For example, the WTRU may be configured with one or more of time-domain allocations, subframe number, and/or slot numbers during which the ROs may be configured. Using this parameter, the WTRU may determine the RO slot, for example within the corresponding subframe. The WTRU may transmit the configured PRACH in one or more of the determined ROs.

The WTRU may be configured with a starting symbol. For example, the WTRU may determine the symbol-level index corresponding to the starting position of the first RO transmission, for example within the indicated and/or configured RO slot.

The WTRU may be configured with a number of PRACH slots, for example within a slot with SCS of 60 KHz. For example, the WTRU may be indicated with the number of PRACH slots within a reference slot with SCS of 60 KHz. In another example, the WTRU may be configured with the number of PRACH slots for high SCS values, such as for example 120 kHz, 480 kHz, 960 kHz, etc. The WTRU may consider the PRACH slot with SCS of 60 kHz as the reference slot.

The WTRU may be configured with a number of time-domain PRACH occasions, for example within a PRACH slot (Nₜ^{RA,slot}). For example, the WTRU may be configured with the number of consecutive ROs that are located within a PRACH slot in time domain. The WTRU may be configured with a PRACH duration. For example, the WTRU may be configured with the duration of an RO in number of symbols.

A WTRU may receive the frequency domain resource allocations for the ROs, for example based on one or more of higher-layer parameters. The one or more higher layer parameters may include a msg1-FrequencyStart, a msgA-RO-FrequencyStart, a msg1-FDM, and/or a msgA-RO-FDM. A msg1-FrequencyStart and/or msgA-RO-FrequencyStart, for example if configured, may indicate the offset of the lowest PRACH transmission occasion in frequency domain with respect to the PRB 0. A msg1-FDM and/or msgA-RO-FDM, for example if configured, may indicate the number of PRACH transmission occasions that are frequency division multiplexed in one time-domain RO. The WTRU may receive, identify, and/or be configured with the number of ROs in frequency domain (M), for example per each time-domain PRACH occasion based on the higher layer parameter (e.g., msg1-FDM, msg1-FDM-16, or msgA-RO-FDM, if configured) msg1-FDM may equal {one, two, four, eight}. The WTRU may number the PRACH frequency resources n_{RA}={0,1, . . . , M−1}, for example starting from the lowest frequency, in increasing order in the initial uplink BWP during the initial access or the active uplink BWP (e.g., otherwise).

A WTRU may receive the association and/or mapping between the SS/PBCH block indexes and PRACH transmission occasions, for example based on higher layer parameter ssb-perRACH-OccasionAndCB-PreamblesPerSSB={⅛, ¼, ½, 1, 2, 4, 8, 16}. The parameter may indicate the number of SS/PBCH block indexes associated with a PRACH transmission occasion in addition to, or alternatively to, the number of preambles per SS/PBCH block index per PRACH occasion. The above mentioned parameters are non-limiting examples of the parameters that may be included in RACH configuration information. One or more of these parameters may be included. Other parameters may alternatively, or additionally, be included.

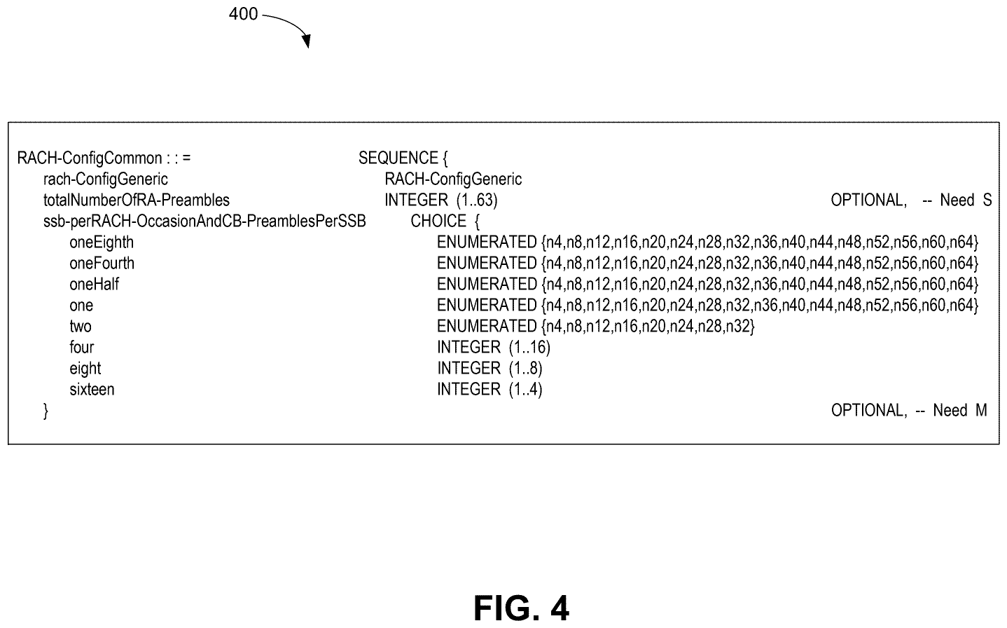

There may be SSB to RO Mapping. A WTRU may be provided with a number of SSB indexes associated with one RACH occasion by ssb-perRACH-OccasionAndCB-PreamblesPerSSB, for example in a random access procedure. The WTRU may additionally, or alternatively, be provided with a number of SSB indexes associated with one RACH occasion by ssb-perRACH-OccasionAndCB-PreamblesPerSSB within an SSB-RO mapping cycle. FIG. 4 shows an example 400 of an RRC configuration for SSB-RO mapping. For example, the SSB-RRC configuration may include ssb-perRACH-OccasionAndCB-PreamblesPerSSB. The RRC configuration may include an SSB-RO mapping, as discussed herein. For example, the RRC configuration may include a mapping of SSBs, ROs, and/or preambles.

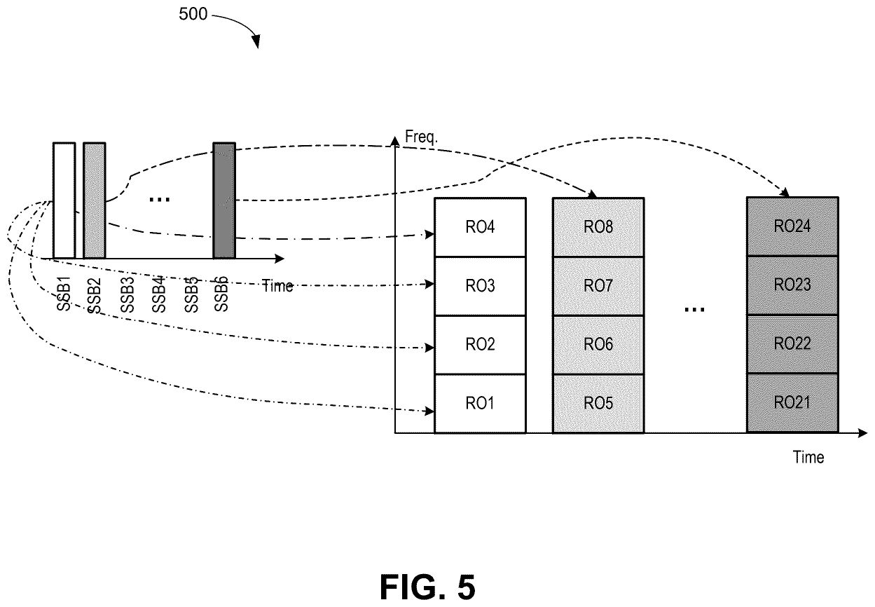

FIG. 5 is an example 500 of SSB-RO mapping. An SSB (e.g., SSB index) may be In an mapped to N=4 configured consecutive ROs (e.g., each SSB may be associated with four ROs). The ROs may be consecutive or non-consecutive. An SSB (e.g., SSB index) may additionally, or alternatively, be mapped to ssb-perRACH-OccasionAndCB-PreamblesPerSSB=¼, Total number of SSBs=6, and/or Msg1-FDM=4. For example, the WTRU may select one RO randomly out of the N configured ROs to transmit PRACH preamble.

There may be SSB to RO mapping. A WTRU may be provided with a number of SSB indexes, for example associated with a (e.g., one) RACH. There may be RO selection for estimation SSB beams. An AIML-capable WTRU may predict RSRP, for example of one or more of the estimation SSB beams based on measurements of transmitted SSBs. The WTRU may (e.g., then) determine whether to perform random access for the estimation SSB beams, for example based on conditions (e.g., during initial access, and/or BFR, etc).

A WTRU may receive a set of configurations on RACH configurations for transmitted and estimation SSB beams (e.g., within an SSB burst) via SIB1 (or RRC). A configuration may include one or more of a set of transmitted SSBs, a set B of transmitted SSBs, a set of estimation SSBs (e.g., or set A), a set A transmission periodicity (e.g., (explicitly or implicitly based on set B and SIB1 periodicity), an AIML model index, a first set of RACH occasion time/frequency configurations, and/or a second set of RACH occasion time/frequency configurations. The set of transmitted SSBs may be via ssb-PositionsInBurst. The set B transmitted SSBs may be via ssb-PositionsInBurst-SetB. Set B may be the same as set of transmitted SSBs in SSB bursts with only including set B SSB beams. The set of estimation SSBs (e.g., or set A) may be via ssb-PositionsInBurst-SetA. The AIML model index(es) may be used for SSB predictions. The first set of RACH occasion (RO) time/frequency configurations may be associated with transmitted SSBs. The second set of RACH occasion (RO) time/frequency configurations may be associated with estimation SSBs. The second set may be an absolute set of configurations, or may be a relative set of time/frequency configurations (e.g., relative to the first set time/frequency configurations).

There may be a subset of allowed estimation SSBs, for example for PRACH transmission. The WTRU may receive an indication of a subset of SSBs from the configured set of estimation SSBs (e.g., via SIB1) (e.g., SSB-subset-Est), for example for which the WTRU may (e.g., is allowed to) transmit PRACH preambles (e.g., in the associated ROs). Systems and methods may allow for traffic control and/or power saving, for example as a gNB may not activate and/or use all UL beams. A WTRU may receive and/or measure RSRP for one or more of the configured transmitted SSBs. The WTRU may predict RSRP for one or more of the estimation SSBs. The WTRU may determine that the best beam among transmitted and estimation SSBs (e.g., with highest measured or predicted RSRP) is one of the estimation beams.

There may be one or more conditions on selecting an estimation SSB for RACH. A WTRU may determine whether to (e.g., it can) select the predicted (e.g., best) estimation SSB for PRACH transmission, for example if the predicted (e.g., best) SSB in within the indicated subset of allowed estimation SSBs and/or based on one or more conditions (e.g., being satisfied). The one or more conditions may include one or more of an AIML model index, an AIML model performance accuracy, a set A periodicity, a number of transmitted SSBs, and/or a prioritization. Prioritizations may be based on an RA triggered event, a time sensitive event (e.g., BFR, and/or SR, etc.), and/or other events (e.g., initial access, and/or PDCCH order, etc.

If the predicted (e.g., best) estimation SSB is within the indicated subset of allowed estimation SSBs and/or one or more conditions are satisfied for example, the WTRU may determine the RO associated with the predicted (e.g., best) estimation SSB. There may be SSB-RO mapping. A WTRU may determine ROs (e.g., based on configured second set of RO configurations) and/or SSB-RO mapping for estimation SSBs, for example based on the configured estimation SSBs and/or the received indication on the subset of allowed estimation SSBs. The WTRU may determine SSB-RO mapping (e.g., only) for the ROs that are associated with the indicated subset of allowed estimation SSBs. If the predicted (e.g., best) estimation SSB is not within the indicated subset of allowed estimation SSBs and/or one or more conditions are not satisfied for example, the WTRU may (e.g., otherwise) select the best transmitted SSB (e.g., with highest measured RSRP) and/or determine the RO associated with the (e.g., best) transmitted SSB.

The WTRU may transmit PRACH on the determined RO. A WTRU may monitor, detect, and/or receive an SSB, for example within an SSB burst. The WTRU may decode and/or receive one or more configuration information as part of the detected SSB. For example, the WTRU may receive the configuration information via one or more of PBCH, MIB, and/or one or more SIBs, for example that are included in and/or associated with the detected SSB.

There may be one or more beam prediction configurations. The WTRU may receive, determine, be configured, and/or indicated with one or more configuration information to be used for SSB beam predictions and/or determination, for example in spatial domain and/or time domain (e.g., based on AIML systems). For example, the WTRU may receive the configuration information via one or more of SIB, RRC, MAC-CE, and/or DCI, etc. The indicated and/or configured configuration information may be one or more of cell-common, group-common, and/or WTRU-specific, etc. The configuration information may include one or more of a set of transmitted set B SSBs, a set of estimation SSBs, a set B transmission periodicity, a set A transmission periodicity, and/or an AIML model index.

The configuration information may include a set of transmitted set B SSBs. For example, the WTRU may be configured and/or indicated with the set of transmitted SSBs and/or set B SSB beams in an SSB burst (e.g., via ssb-PositionsInBurst-SetB).

The configuration information may include a set of estimation SSBs. For example, the WTRU may be configured and/or indicated with the set of estimation SSBs and/or set A SSB beams in one or more of a received, detected, indicated, determined, and/or configured SSB burst (e.g., via ssb-PositionsInBurst-SetA).

The configuration information may include a set B transmission periodicity. For example, the WTRU may be configured and/or indicated with the time period for the SSB bursts that, for example include transmitted SSBs and/or set B SSB beams.

The configuration information may include a set A transmission periodicity. For example, the WTRU may be configured and/or indicated with the time period for the SSB bursts that, for example include estimation SSBs and/or set B SSB beams.

The configuration information may include one or more AIML model index(es) to be used for SSB predictions. For example, the WTRU may be configured and/or indicated with one or more AIML model indexes that, for example the WTRU may use for SSB predictions.

A WTRU may receive explicit indications and/or configurations. The WTRU may be configured with a set of transmitted SSBs and/or set B SSB beams, for example by explicit indication (e.g., via ssb-PositionsInBurst-SetB). For example, the WTRU may receive a bitmap. A size of the bitmap may be equal to the total number of SSB indexes. For example, the total number of SSB indexes in FR1 may be 8 SSBs and/or the total number of SSB indexes in FR2 may be 64 SSBs. The bits in the bitmap may correspond to the SSBs, for example in the increasing order of SSB indexes. If a first bit in the bitmap is equal to a first value (e.g., value one) for example, the WTRU may determine that the SSB with the SSB index associated to the first bit may be transmitted as in set B SSBs. Alternatively, or additionally, if a second bit in the bitmap is equal to a second value (e.g., value zero) for example, the WTRU may determine that the SSB with the SSB index associated to the second bit may not be transmitted.

The WTRU may be configured with a set of estimation SSBs. For example, the WTRU may be configured with the set of transmitted SSBs and/or set B SSB beams by explicit indication (e.g., via ssb-PositionsInBurst-SetA). The WTRU may receive a bitmap. A size of the bitmap may be equal to the total number of SSB indexes. For example, the total number of SSB indexes in FR1 may be 8 SSBs and/or the total number of SSB indexes in FR2 may be 64 SSBs. The bits in the bitmap may correspond to the SSBs in the increasing order of SSB indexes. If a first bit in the bitmap is equal to a first value (e.g., value one) for example, the WTRU may determine that the SSB with the SSB index associated to the first bit may belong to the set of estimation SSBs. Alternatively, or additionally, if a second bit in the bitmap is equal to a second value (e.g., value zero) for example, the WTRU may determine that the SSB with the SSB index associated to the second bit may not belong to the set of estimation SSBs.

The WTRU may be configured with a set B transmission periodicity. The WTRU may be explicitly configured with the time period for the SSB bursts that, for example may include transmitted SSBs and/or set B SSB beams.

The WTRU may be configured with a set A transmission periodicity. The WTRU may be explicitly configured with the time period for the SSB bursts that, for example may include estimation SSBs and/or set A SSB beams.

The WTRU may be configured with an AIML model. The WTRU may use the configured and/or indicated AIML model indexes for predicting the estimation SSB beams, for example based on the measurements on transmitted SSB beams. The WTRU may be (pre)configured (e.g., via RRC) with a set of one or more AIML model indexes. The configured AIML model indexes may indicate one or more of (pre) configured AIML models and/or corresponding trained weights and/or coefficients. The WTRU may receive indications (e.g., via SIB, DCI, MAC-CE, etc.) to use one or more of the indicated AIML model indexes from the (pre) configured set of AIML model indexes.

Additionally, or alternatively, the WTRU may implicitly determine the configurations. The WTRU may be configured with a set of estimation SSBs. For example if the set of estimation SSBs are not explicitly indicated, the WTRU may determine the set of estimation SSBs by excluding the configured and/or indicated set of set B beams from all possible SSB beams. The WTRU may be (pre)configured and/or indicated with maximum number of SSBs that, for example may be (e.g., are possible to be) transmitted within an SSB burst (e.g., maximum 8 SSBs in FR1). If the WTRU receives configuration that a first value of SSBs (e.g., 3 SSBs) is included in set B beams for example, the WTRU may determine the remaining SSBs (e.g., 5 remaining SSBs out of 8 possible SSBs) to be included in estimation SSBs.

The WTRU may be configured with a set B transmission periodicity. The WTRU may be configured and/or indicated to determine the time period for the SSB bursts that, for example may include transmitted SSBs and/or set B SSB beams based on one or more cell-common configured time period for the transmission of SSB bursts. The WTRU may be configured and/or indicated to determine the set B transmission time period, for example based on the (pre) configured time period for SSB burst transmissions in initial BWP. The WTRU may be configured and/or indicated to determine the set B transmission time period, for example based on the configured time period for SSB burst transmissions in active BWP.

The WTRU may be configured with a set A transmission periodicity. The WTRU may be configured and/or indicated to determine the time period for SSB bursts that, for example may include estimation SSBs and/or set A SSBs based on one or more other configured parameters and/or time periods. The WTRU may be configured with the set A transmission periodicity, for example based on the configured set B transmission periodicity. The WTRU may be configured with the ratio of set A transmission frequency, for example based on the set B transmission frequency. The WTRU may be configured with set A transmission periodicity to be n times (e.g., 8 times) the set B periodicity. The WTRU may be configured and/or indicated that after every n SSB bursts including only set B SSBs for example, the WTRU may receive an SSB burst including only set A SSB beams. The WTRU may be configured and/or indicated that after every n SSB bursts including only set B SSBs for example, the WTRU may receive an SSB burst including both set A and set B SSB beams.

The WTRU may be configured with one or more SSB burst types. The WTRU may receive, determine, be configured, and/or indicated with one or more SSB burst types. For example, the WTRU may be configured and/or indicated with a first type SSB burst, a second type SSB burst, a third type SSB burst, and/or so forth. The WTRU may be (pre)configured and/or indicated that the first type SSB burst may (e.g., only) include set B SSB beams. The WTRU may be (pre)configured and/or indicated that the second type SSB burst may include both set A and set B SSB beams. The WTRU may be (pre)configured and/or indicated that the third type SSB burst may (e.g., only) include set A SSB beams, etc. The WTRU that has received and/or detected a first type SSB burst for example, may measure the transmitted SSBs and/or predict and/or determine one or more estimation beams accordingly.

The WTRU may be configured with a RACH configuration. A WTRU, that for example has received and/or detected at least one SSB from a received and/or detected first type SSB burst (e.g., SSB burst only including set B SSB beams), may receive, determine, be indicated, and/or configured with one or more configuration information on one more RACH Occasion (RO) types. The WTRU may receive, be configured, and/or indicated with one or more of Type-1 RO(s) and/or Type-2 RO(s), associated with RACH configurations for transmitted SSBs and estimation SSBs, respectively. The WTRU may receive the RACH configuration for the transmitted and/or estimation SSBs via one or more of SIB1, SIB2, and so forth. The WTRU may receive the RACH configuration for the transmitted and/or estimation SSBs via one or more of RRC, MAC-CE, and/or DCI, etc. For example the indicated and/or configured RACH configurations may be one or more of cell-common, group-common, and/or WTRU-specific, etc.

The received, indicated, and/or configured RACH configurations may include one or more of Type-1 RO and/or Type-2 RO. Type-1 RO may include RACH configuration(s) for transmitted SSBs. For example, the WTRU may receive, be configured, and/or indicated with one or more configuration information for the ROs associated with the transmitted SSBs. The configuration information may include one or more of ROs' time and frequency resources, SSB-to-RO mapping parameters, repetition parameters, and/or power ramping parameters, etc.

Type-2 RO may include RACH configuration for transmitted SSBs. For example, the WTRU may receive, be configured, and/or indicated with one or more configuration information for the ROs associated with the estimation SSBs. The configuration information may include one or more of Type-2 ROs' time and frequency resources, PRACH occasions, RACH slots, PRACH slots, SSB-to-RO mapping parameters, repetition parameters, and/or power ramping parameters, etc.

There may be a subset of allowed estimation SSBs, for example for PRACH transmission. A WTRU may receive and/or detect at least one SSB (e.g., from the configured set of transmitted SSBs) from a received and/or detected first type SSB burst (e.g., SSB burst only including set B SSB beams), and/or predict and/or determine at least one estimation SSB (e.g., from the configured set of estimation SSBs, e.g., via ssb-PositionsInBurst-SetA). The WTRU may (e.g., then) receive, determine, be indicated, and/or configured with one or more configuration information and/or indications, for example indicating a subset of allowed estimation SSBs for PRACH transmission (e.g., via SSB-subset-Est).

The WTRU may receive the configuration information and/or indication(s) via one or more of SIB, RRC, MAC-CE, and/or DCI, etc. The WTRU may receive the indication on the subset of allowed estimation SSBs via one or more of a bitmap indication. A size of the bitmap may be equal to the number of estimation SSBs (e.g., indicated via ssb-PositionsInBurst-SetA). Each bit in the bitmap may correspond to an estimation SSB, for example in the increasing order of estimation SSB indexes. For example, the first bit may correspond to the SSB with the lowest SSB index, the second bit may correspond to the SSB with the second lowest SSB index, and so forth.

If a first (e.g., bit) indication corresponding to a first estimation SSB index includes a first value (e.g., value one) for example, the WTRU may determine that the WTRU may be allowed to perform RACH procedure for the corresponding estimation SSB. If a second (e.g., bit) indication corresponding to a second estimation SSB index includes a second value (e.g., value zero) for example, the WTRU may determine that the WTRU may not be allowed to perform RACH procedure and/or to send PRACH preamble for the corresponding estimation SSB.

There may be one or more conditions on selecting an estimation SSB for RACH. A WTRU may detect, receive, and/or measure one or more transmission SSBs, for example within an SSB burst. The WTRU may estimate, predict, and/or determine one or more parameters for one or more estimation SSBs within the SSB burst. The WTRU may measure received power (e.g., RSRP) for one or more of the transmitted SSBs and/or the WTRU may predict and/or determine the received power (e.g., RSRP) for one or more of the estimation SSBs. The WTRU may determine and/or select an SSB (e.g., best SSB), for example based on one or more of the measured, predicted, and/or determined parameters. For example, the WTRU may determine and/or select the (e.g., best) SSB based on the one with the highest received power. The WTRU may determine that the selected (e.g., best) SSB is from the configured set of estimation SSBs.

If the WTRU selects an SSB (e.g., best SSB) from the set of estimation beams, the WTRU may determine if the WTRU may use the selected estimation SSB for RACH procedure based on one or more conditions. The WTRU may receive one or more of configuration information and/or indications on the conditions, for example to be used for determining whether the selected estimation SSB can be used for RACH procedure. For example, the WTRU may receive the configuration information and indications via one or more of SIB, RRC, MAC-CE, DCI, etc. The WTRU may determine the best (e.g., selected) SSB to be the SSB with the highest RSRP value.

The WTRU may receive, determine, and/or be configured with an AIML model index. For example, the WTRU may determine if the WTRU supports and/or if the WTRU has the trained coefficients and/or weights corresponding to the configured and/or indicated AIML model index for beam prediction. The WTRU may determine that the WTRU may use the selected estimation SSB for a RACH procedure and/or (e.g., further) connection to the corresponding cell, for example if the WTRU supports the configured beam prediction AIML model index. The WTRU may determine that the WTRU may not use the selected estimation SSB for RACH procedure and/or (e.g., further) connection to the corresponding cell, for example if the WTRU does not support the configured beam prediction AIML model index.

The WTRU may receive, determine, and/or be configured with an AIML model performance accuracy. The WTRU may determine and/or measure one or more performance accuracy parameters, for example based on one or more predictions. For example, the WTRU may compare the difference between the measured parameters and predicted parameters. For a system with S transmitted SSB beams for example, the WTRU may use the measured parameters based on one or more of the first, second, till S-1-th SSBs and/or may predict the quality parameters for the S-th SSB. The WTRU may predict the received power (e.g., RSRP), for example for the S-th SSB. The WTRU may (e.g., then) measure the received power (e.g., RSRP), for example based on the S-th SSB and/or determine the difference between the measured and predicted received power for the S-th SSB.

The WTRU may compare the determined difference value on accuracy parameters with one or more of the corresponding configured thresholds. In an example, the WTRU may determine that the WTRU may use the selected (e.g., predicted) estimation SSB for RACH procedure and further connection to the corresponding cell, if the difference between the measured and predicted accuracy parameters is lower than a corresponding configured threshold. In another example, the WTRU may determine that the WTRU may not use the selected (e.g., predicted) estimation SSB for RACH procedure and further connection to the corresponding cell, if the difference between the measured and predicted accuracy parameters is higher than the corresponding configured threshold.

The WTRU may receive, determine, and/or be configured with a set A periodicity. The WTRU may determine that the WTRU may use the selected estimation SSB for RACH procedure and/or (e.g., further) connection to the corresponding cell, for example if the configured and/or indicated set A periodicity is lower than a configured, indicated, and/or determined threshold. The WTRU may determine that the WTRU may not use the selected estimation SSB for RACH procedure and/or (e.g., further) connection to the corresponding cell, for example if the configured and/or indicated set A periodicity is higher than the configured, indicated, and/or determined threshold. The WTRU may determine the threshold on set A periodicity based on one or more of WTRU capability, WTRU's AIML system and models, WTRU's processor, WTRU's processing time, and/or WTRU's latency requirements, etc.

The WTRU may receive, determine, and/or be configured with a number of transmitted SSBs. The WTRU may determine that the WTRU may use the selected estimation SSB for RACH procedure and/or (e.g., further) connection to the corresponding cell, for example if the configured and/or indicated number of transmitted SSBs is higher than a configured, indicated, and/or determined threshold. The WTRU may determine that the WTRU may not use the selected estimation SSB for RACH procedure and/or (e.g., further) connection to the corresponding cell, for example if the configured and/or indicated number of transmitted SSBs is lower than the configured, indicated, and/or determined threshold. The WTRU may determine the threshold on the number of transmitted SSBs, for example based on one or more of WTRU capability, WTRU's AIML system and models, and/or WTRU's processor, etc.

The WTRU may receive, determine, and/or be configured with one or more prioritizations, for example based on RACH triggering events. The WTRU may determine whether the WTRU may use the selected estimation SSB for RACH procedure, for example based on the event that triggered the RACH procedure. Additionally, or alternatively, the WTRU may use the selected estimation SSB for RACH procedure based on one or more configured, indicated, and/or determined priority levels. The WTRU may determine, be configured, and/or indicated to use the selected estimation SSB for RACH transmission, for example if the triggering events are non-time-sensitive events. The WTRU may determine, be configured, and/or indicated to use the selected estimation SSB for RACH transmission, for example if the triggering events are one or more of initial access, PDCCH order, RRC connection re-establishment, and/or mobility, etc. The WTRU may determine, be configured, and/or indicated to not use the selected estimation SSB for RACH transmission, for example if the triggering events are time-sensitive (e.g., DL and/or UL out of sync, BFR, and/or SR failure, etc.)

There may be SSB-RO Mapping. A WTRU may have receive, be configured, and/or indicated with the set of estimation SSBs (e.g., via ssb-PositionsInBurst-SetA), for example corresponding to the detected and/or received SSB burst. The WTRU may (e.g., then) determine, be indicated, and/or configured with whether the WTRU may (e.g., is allowed to) determine RO resources (e.g., via SSB-subset-Est), determine SSB-to-RO mapping, and/or (e.g., further) transmit PRACH preambles on the determined RO resources associated with the estimation SSBs. In an example, the ROs associated with estimation SSBs may be from the set of Type-2 ROs.

A WTRU may determine the SSB-to-RO mapping for Type-2 ROs for the configured estimation SSBs (e.g., via ssb-PositionsInBurst-SetA), for example for which the WTRU is allowed to perform RACH procedure and/or transmit PRACH preamble. The WTRU may determine if the WTRU is allowed to perform RACH procedure for an estimation SSB, for example based on the received (e.g., bitmap) indication on the subset of allowed estimation SSBs (e.g., via SSB-subset-Est) as described herein.

For the Type-2 ROs (e.g., ROs associated with estimation SSBs) for example, there SSB-RO mapping. A WTRU may map the configured estimation SSBs indexes (e.g., indicated via ssb-PositionsInBurst-SetA), for example that are indicated to be allowed to be used for PRACH transmission (e.g., indicated via subset of allowed estimation SSBs for PRACH transmission, e.g., SSB-subset-Est) to the configured valid Type-2 ROs. The WTRU may map the configured estimation SSB indexes in an order. The order may include (e.g., first) an increasing order of preamble indexes within a single Type-2 PRACH occasion. The order may include (e.g., second) in increasing order of frequency resource indexes for frequency multiplexed Type-2 PRACH occasions. The order may include (e.g., third) in increasing order of time resource indexes for time multiplexed Type-2 PRACH occasions within a Type-2 PRACH slot. The order may include (e.g., fourth) in increasing order of indexes for Type-2 RACH slots.

There may be RO selection. A WTRU may detect, receive, measure, determine, be configured, and/or indicated to select an/or use an estimation SSB for RACH transmission. For example, the triggering events may be one or more of initial access, PDCCH order, RRC connection re-establishment, mobility, DL and/or UL out of sync, BFR, and/or SR failure, etc. A WTRU may determine and/or be triggered to perform BFR. The WTRU may receive a PDCCH order.

The WTRU may determine and/or be triggered to perform BFR based on one or more beam failure instances and/or one or more indicated, determined, and/or configured events and/or conditions. The WTRU may be configured with a set of candidate SSB beams for BFR procedure. Additionally, or alternatively, the WTRU may monitor, detect, receive, and/or measure one or more of the configured candidate SSB beams within a detected and/or received SSB burst. The WTRU may select one of the candidate SSB beams to perform RACH procedure (e.g., accordingly). In an example, the WTRU may select the (e.g., best) candidate SSB beam with the highest measured received power, for example of a reference signal received power (RSRP). The WTRU may determine that the selected candidate SSB may be one of the configured estimation beams within the detected and/or received SSB burst.

The WTRU may receive a PDCCH order (e.g., via DCI) to perform one or more RACH procedures. The WTRU may receive the SSB index as part of the PDCCH order for which to perform the RACH procedure. Alternatively, or additionally, the WTRU may receive an indication to select an SSB (e.g., the best SSB) from an SSB burst and/or perform RACH procedure. The WTRU may be configured with the preamble to be used for the corresponding CFRA procedure.

A WTRU, that for example has selected an estimation SSB to be the (e.g., best) beam to perform RACH procedure, may determine that the conditions to use the selected estimation SSB are satisfied (e.g., as described herein). The WTRU may determine that the selected estimation SSB is within the subset of allowed SSBs for which the RACH procedure is allowed (e.g., as described herein). The WTRU may (e.g., then) determine the RO associated with the predicted (e.g., best) estimation SSB from the set of Type-2 ROs, for example based on the determined SSB-to-RO mapping.

The WTRU may (e.g., otherwise) determine that the conditions to use the selected estimation SSB are not satisfied and/or that the WTRU may determine that the RACH procedure is not allowed for the selected estimation SSB. The WTRU may (e.g., then) select the second (e.g., best) SSB. The second (e.g., best) SSB may be from the set of configured transmitted and/or estimation SSB beams. If the selected second (e.g., best) SSB is from the set of transmitted SSB for example, the WTRU may determine the RO associated with the selected (e.g., best) transmitted SSB from the set of Type-1 ROs based on the determined SSB-to-RO mapping.

If the conditions to use the selected estimation SSB are not satisfied and/or the WTRU determines that the RACH procedure is not allowed for the selected estimation SSB for example, the WTRU may report the selected estimation SSB (e.g., to the gNB) as part of a (e.g., next) communication and/or signaling. The WTRU may indicate the selected estimation SSB as one or more of a part of Msg 3, via CSI-report, a specific SR, and/or another signaling, for example after (re)connecting to the cell.

The WTRU may transmit PRACH preamble based on the determined RO. There may be an additional or joint indication of set A and/or set B SSB beams. A WTRU may receive a single and/or joint indication, for example including (e.g., both) transmitted and/or estimation SSB beams within a received and/or detected SSB burst. The WTRU may receive an indication (e.g., via ssb-PositionsInBurst,). The indication may include an indication of the transmitted SSB beams and/or the estimation SSB beams. WTRUs, that for example do not support predicting estimation SSB beams, may assume that estimation SSBs are also transmitted (e.g., based on the indication via ssb-PositionsInBurst). WTRUs, that for example do not support predicting estimation SSB beams, may not select estimation SSBs (e.g., since they are not actually being transmitted).

A WTRU, for example that supports determining and/or predicting estimation SSBs, may receive the set of SSBs in set A (e.g., estimation SSBs) and set B (e.g., transmitted SSBs) via separate configurations. The WTRU may receive two separate explicit indications including an indication of set A SSBs (e.g., via ssb-PositionsInBurst-SetA) and an indication of set B SSBs (e.g., via ssb-PositionsInBurst-SetB). In another example, the WTRU may receive explicit indication of Sset A SSBs (e.g., via ssb-PositionsInBurst-SetA) and/or the WTRU may implicitly determine the set B SSBs based on the indicated set A and/or the received joint indication of set A and set B SSBs. In another example, the WTRU may receive explicit indication of set B SSBs (e.g., via ssb-PositionsInBurst-SetB) and/or the WTRU may implicitly determine the set A SSBs based on the indicated set B and/or the received joint indication of set A and set B SSBs.

The WTRU may receive one or more of the joint indication of set A and set B SSBs (e.g., via ssb-PositionsInBurst), the indication of set A SSBs (e.g., via ssb-PositionsInBurst-Set A), and/or the indication of set B SSBs (e.g., via ssb-PositionsInBurst-SetB), for example based on bitmap indications. The WTRU may receive a bitmap. A size of the bitmap may be equal to the total number of SSB indexes. In an example, the total number of SSB indexes in FR1 may be 8 SSBs and/or the total number of SSB indexes in FR2 may be 64 SSBs. The bits in the bitmap may correspond to the SSBs in the increasing order of SSB indexes.

There may be a bitmap indication on the joint indication of set A and set B SSBs. For example if a first bit in the bitmap is equal to a first value (e.g., value one), the WTRU may determine that the SSB with the SSB index associated to the first bit may belong to set A or set B. Alternatively, or additionally, if a second bit in the bitmap is equal to a second value (e.g., value zero) for example, the WTRU may determine that the SSB with the SSB index associated to the second bit may not be used and/or may not belong to either of set A or set B.

There may be a bitmap indication on set A SSBs. For example if a first bit in the bitmap is equal to a first value (e.g., value one), the WTRU may determine that the SSB with the SSB index associated to the first bit may belong to set A. Alternatively, or additionally, if a second bit in the bitmap is equal to a second value (e.g., value zero) for example, the WTRU may determine that the SSB with the SSB index associated to the second bit may not belong to set A.

There may be a bitmap indication on set B SSBs. For example if a first bit in the bitmap is equal to a first value (e.g., value one), the WTRU may determine that the SSB with the SSB index associated to the first bit may belong to set B. Alternatively, or additionally, if a second bit in the bitmap is equal to a second value (e.g., value zero) for example, the WTRU may determine that the SSB with the SSB index associated to the second bit may not belong to set B.

There may be RACH configuration. If the joint indication of set A and set B is used for example, the WTRU may receive, determine, be indicated, and/or configured with one set of configuration information for RACH occasions corresponding to SSBs belonging to both set A and set B SSB beams. The WTRU may receive the RACH configuration via one or more of SIB1, SIB2, and/or so forth. In another example, the WTRU may receive the RACH configuration via one or mor of RRC, MAC-CE, and/or DCI, etc. For example, the indicated and/or configured RACH configurations may include one or more of cell-common, group-common, and/or WTRU-specific, etc. The received, indicated, and/or configured RACH configurations may include one or more of ROs' time and frequency resources, and/or SSB-to-RO mapping parameters, etc. The WTRU may receive two separate set of RACH configurations on, for example repetition parameters and/or power ramping parameters corresponding to set A and set B RACH procedures.

There may be SSB-RO mapping for the joint indication. A WTRU that may have determined, received, been configured, and/or indicated with the set of estimation SSBs (e.g., via ssb-PositionsInBurst-Set A) corresponding to the detected and/or received SSB burst for example, may determine, be indicated, and/or configured on whether the WTRU is allowed to determine RO resources (e.g., via SSB-subset-Est), determine SSB-to-RO mapping, and/or (e.g., further) transmit PRACH preambles on the determined RO resources. A WTRU may determine the SSB-to-RO mapping for the configured estimation SSBs (e.g., via ssb-PositionsInBurst-SetA), for example for which the WTRU is allowed to perform RACH procedure and/or transmit PRACH preamble. The WTRU may determine if the WTRU is allowed to perform RACH procedure for an estimation SSB, for example based on the received (e.g., bitmap) indication on the subset of allowed estimation SSBs (e.g., via SSB-subset-Est).

A WTRU may perform the SSB-RO mapping. A WTRU may map the configured estimation SSBs indexes (e.g., indicated via ssb-PositionsInBurst-SetA) that for example are indicated to be allowed to be used for PRACH transmission (e.g., indicated via subset of allowed estimation SSBs for PRACH transmission, e.g., SSB-subset-Est) to the configured ROs in an order. The order may include (e.g., first) an increasing order of preamble indexes within a single PRACH occasion. The order may include (e.g., second) in increasing order of frequency resource indexes for frequency multiplexed PRACH occasions. The order may include (e.g., third) in increasing order of time resource indexes for time multiplexed PRACH occasions within a PRACH slot. The order may include (e.g., fourth) in increasing order of indexes for RACH slots.

There may be RO selection for the joint indication. A WTRU, for example that has selected an estimation SSB to be the (e.g., best) beam to perform RACH procedure (e.g., during initial access), may determine that the conditions to use the selected estimation SSB are satisfied (e.g., as described herein). The WTRU may determine that the selected estimation SSB is within the subset of allowed SSBs, for example for which the RACH procedure is allowed (e.g., as described herein). The WTRU may (e.g., then) determine the RO associated with the predicted (e.g., best) estimation SSB from the set of ROs, for example based on the determined SSB-to-RO mapping.

The WTRU may (e.g., otherwise) determine that the conditions to use the selected estimation SSB are not satisfied and/or that the WTRU may determine that the RACH procedure is not allowed for the selected estimation SSB. The WTRU may (e.g., then) select the second (e.g., best) SSB. The second (e.g., best) SSB may be from the set of configured transmitted and/or estimation SSB beams. If the selected second (e.g., best) SSB is from the set of transmitted SSB for example, the WTRU may determine the RO associated with the selected (e.g., best) transmitted SSB from the set of ROs based on the determined SSB-to-RO mapping. The WTRU may transmit PRACH preamble based on the determined RO.

There may be one or more RACH configurations for estimation SSB beams. A WTRU may receive an indication on (e.g., set of transmitted SSBs) a set B (e.g., ssb-PositionsInBurst-SetB), a set of estimation SSBs, and/or a set A SSB beams (ssb-PositionsInBurst-SetA), for example via SIB1. The WTRU may receive RACH configurations for a first set of ROs (Type-1 ROs) that, for example may be associated with the transmitted SSBs, and/or a second set of ROs (type-2 ROs) that may be associated with the estimation SSBs.

There may be two separate sets of RACH configurations. The WTRU may receive a first and a second set of RO configurations associated with Type-1 and Type-2 ROs, respectively. Type-1 ROs may be non-AIML (e.g., not determined using AIML) and/or associated with transmitted SSBs. Type-2 ROs may be AIML (e.g., determined using AIML) and/or associated with estimation SSBs. The RACH configurations may include one or more of ROs' time and frequency config., SSB-to-RO mapping, power ramping parameters, and/or RACH repetition parameters, etc. The sets may be spread in time domain or frequency domain

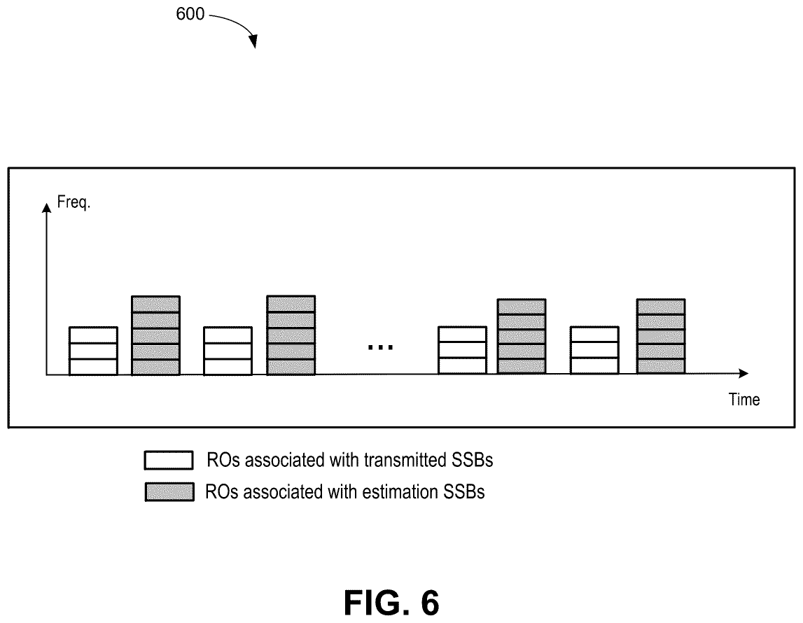

FIG. 6 shows an example 600 of two separate sets of RACH configurations. The two separate RACH configurations may have indicated two time division multiplexed set of ROs. The two sets of RACH configurations each include respective ROs. A first set of RACH configurations includes ROs associated with transmitted SSBs. A second set of RACH configurations includes ROs associated with estimation SSBs. The first set and second set of RACH configurations are shown graphically by time vs. frequency.

The WTRU may determine validity. If a Type-1 RO and a Type-2 RO overlap in time and/or frequency for example, the WTRU determine the Type-1 RO to be valid and/or the Type-2 RO to be invalid. The WTRU may use a second (e.g., best) SSB and perform RACH procedure based on the selected second SSB, for example if the WTRU may not be able to send RACH based on the first selected estimation SSB that is associated with the overlapping Type-2 RO. The WTRU may indicate the first selected SSB to gNB via Msg3, and/or after connecting to the cell.

There may be a single set of RACH configurations. The WTRU may receive a (e.g., explicit) first set of RACH configurations, for example associated with Type-1 ROs. The WTRU may (e.g., implicitly) determine the second set of RACH configurations associated with Type-2 ROs.

The WTRU may receive one or more time and/or frequency offsets, for example to determine the Type-2 ROs based on the configured Type-1 ROs. The WTRU may receive a second (e.g., associated with estimation SSBs) Msg1-FDM, msg1-FrequencyStart, and/or slot offset, etc. The WTRU may determine SSB-to-RO mapping in valid Type-1 and Type-2 ROs. The WTRU may select an SSB (e.g., based on RSRP). The SSB may be from estimation or transmitted SSBs. The WTRU may determine the RO that is associated with the selected SSB. The WTRU may send a PRACH preamble based on the determined RO.

A WTRU may monitor, detect, and/or receive one or more SSBs within an SSB burst. The WTRU may decode and/or receive one or more configuration information, for example as part of the detected SSBs. The WTRU may receive the configuration information via one or more of PBCH, MIB, and/or one or more SIBs that are included in and/or associated with the detected SSB and corresponding SSB burst. For example, the WTRU may receive, determine, be configured, and/or indicated with a set of transmitted SSBs and/or set B SSB beams (e.g., via ssb-PositionsInBurst-SetB) and/or a set of estimation SSBs and/or set A SSB beams (e.g., via ssb-PositionsInBurst-SetA). Alternatively, or additionally, the WTRU may receive and/or be configured and/or indicated with the set A and set B SSB beams via one or more of RRC, MAC-CE, and/or DCI, etc.

A WTRU may receive, determine, be indicated, and/or configured with one or more RACH configurations for a first set of ROs (Type-1 ROs) that, for example may be associated with the transmitted SSBs, and/or a second set of ROs (type-2 ROs) that may be associated with the estimation SSBs. The WTRU may receive the RACH configuration information via one or more of PBCH, MIB, SIB, RRC, MAC-CE, and/or DCI, etc.

There may be two separate sets of RACH configurations. A WTRU may receive, determine, be configured, and/or indicated with a first and a second sets of RACH configurations associated with Type-1 and Type-2 ROs, respectively. For example, the first and second sets of RACH configurations may be separately configured. In another example, the first and second sets of RACH configurations may be mutually exclusive. For example, the WTRU may receive explicit indication of the first and second RACH configurations.

The first and/or second sets of RACH configurations may include configuration information including one o more of RO's time configuration, RO's frequency configuration, SSB-to-RO mapping, power ramping parameter(s), and/or RACH repetition parameter(s), etc.

The first and/or second sets of RACH configurations may include ROs' time configurations. The WTRU may receive a first and/or a second PRACH configuration index indicating RACH configurations in one or more tables, for example including time resources to be used for the configured ROs. The time configuration information may include one or more of a preamble format, a subframe number, a slot number, a starting symbol, a number of PRACH slots within a subframe, a number of time domain PRACH occasions within a PRACH slot, and/or a PRACH duration, etc.

The first and/or second sets of RACH configurations may include ROs' frequency configurations. The WTRU may receive a first and/or a second RACH frequency configuration, including for example, msg1-FDM, msg1-FDM-16, or msgA-RO-FDM (e.g., if configured), and/or msg1-FrequencyStart or msgA-RO-FrequencyStart (e.g., if configured).

The first and/or second sets of RACH configurations may include SSB-to-RO mapping. For example, the WTRU may be configured with a first and/or second parameters indicating the number of SSB indexes associated with a PRACH transmission occasion and/or a the number of preambles per SSB index per PRACH occasion (e.g., via ssb-perRACH-OccasionAndCB-PreamblesPerSSB).

The first and/or second sets of RACH configurations may include power ramping parameters. For example, the WTRU may be configured with a first and/or second power ramping step size (e.g., via powerRampingStep, msgA-PreamblePowerRampingStep, powerRampingStepHighPriority) and/or maximum number of preamble transmissions (e.g., via preamble TransMax, preamble TransMax-Msg1-Repetition, msgA-TransMax, etc.).

The first and/or second sets of RACH configurations may include RACH repetition parameters. For example, the WTRU may be configured with a first and/or second RSRP thresholds for one or more repetition numbers. The Type-1 and/or Type-2 ROs may be configured to be spread in time domain, for example as in FIG. 6. Type-1 ROs (e.g., associated with transmitted SSBs) and Type-2 ROs may be time division multiplexed, in time for example.

A WTRU may determine validity. The WTRU may determine that a first RO from the set of configured Type-1 RO associated with a first transmitted SSB overlaps in time and/or frequency with a second RO from the set of configured Type-2 ROs associated with a second estimation SSB. For example, the first and the second RO may fully or partially overlap. If the WTRU determines that the first and the second ROs overlap for example, the WTRU may determine that the first RO is an valid RO and/or the second RO is an invalid RO. The WTRU (e.g., then) may not be able to use the overlapping second RO associated with the second SSB for RACH transmission.

If the WTRU cannot transmit PRACH of a first (e.g., best) selected estimation SSB due to associated ROs determined as invalid, not allowed, etc. for example, the WTRU may determine a second (e.g., best) SSB and/or perform the RACH procedure associated with the second SSB. The WTRU may indicate and/or report the first selected SSB (e.g., to a gNB), for example via Msg-3, and/or after connecting to the cell (e.g., via CSI report, and/or special SR, etc.).

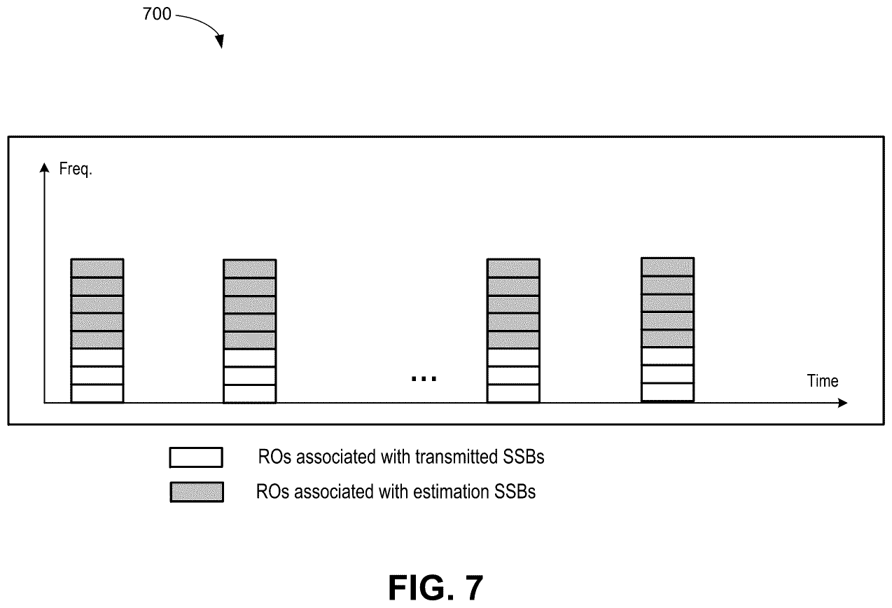

There may be a single set of RACH configurations. FIG. 7 shows an example 700 of a single set of RACH configurations. The set of RACH configurations may include respective. The ROs may include ROs associated with transmitted SSBs and/or ROs associated with estimation SSBs. The set of RACH configurations is shown graphically by time vs. frequency.

A WTRU may (e.g., explicitly) be configured and/or indicated with a first set of RACH configurations associated with Type-1 ROs. Additionally, or alternatively, the WTRU may (e.g., implicitly) determine a second set of RACH configurations associated with Type-2 ROs (e.g., accordingly). For example, the WTRU may receive one or more extra, additional and/or supplementary indications and/or configuration information for determining the second set of RACH configurations based on the configured first set of RACH configurations. For example, the WTRU may receive the supplementary configuration information via one or more of SIB, RRC, MAC-CE, and/or DCI, etc. The WTRU may receive (e.g., supplementary) configuration information including one or more of a time offset, a frequency offset, frequency division multiplexed ROs, an SSB-to-RO mapping, and/or power ramping parameter(s).

The WTRU may receive a time Offset. For example, a WTRU may receive one or more indications and/or configurations on one or more time offset values. The WTRU may use the offset values to determine the random access resources corresponding to Type-2 ROs in time-domain. For example, the WTRU may use the configured and/or indicated offset value with respect to one or more of the configured Type-1 ROs. The offset value may be indicated as a positive or negative slot number (e.g., 0 to 40, and/or-20 to 20, etc.), for example to indicate a slot (e.g., within the corresponding subframe). The WTRU may use the slot time offset value to determine Type-2 RO slots with respect to Type-1 RO slots.

The WTRU may receive a frequency offset. For example, a WTRU may receive one or more indications and/or configurations on one or more frequency offset values. The WTRU may use the offset values to determine the random access resources corresponding to Type-2 ROs in frequency-domain. In an example, the WTRU may use the configured and/or indicated offset value with respect to one or more of the configured Type-1 ROs. The offset value may be indicated as a positive or negative number of one or more of RBs, REs, and/or subbands, etc. The WTRU may use the indicated frequency offset value to determine Type-2 RO frequency resources, for example with respect to Type-1 RO frequency resources.

The WTRU may receive a frequency division multiplexed ROs. For example, the WTRU may receive one or more indications and/or configurations on the number of frequency division multiplexed ROs for Type-2 ROs. In an example, the WTRU may receive separate and/or explicit indication(s) on the number of frequency division multiplexed ROs for type-2 ROs. In another example, the WTRU may receive an indication on the number of frequency division multiplexed Type-2 ROs with respect to the configured frequency division multiplexed Type-1 ROs. The WTRU may (e.g., then) determine the number of frequency division multiplexed Type-2 ROs (e.g., accordingly).

For example, the WTRU may receive indication on f (e.g., f=8) frequency division multiplexed Type-1 ROs. The number of transmitted SSBs S (e.g., S=3) may be lower than the configured f. The WTRU may (e.g., then) receive indications that the WTRU may use the remaining R (R=8−3=5) frequency division multiplexed ROs for Type-2 ROs.

The WTRU may receive an SSB-to-RO mapping. For example, the WTRU may be configured with explicit parameters for Type-2 ROs indicating the number of SSB indexes associated with a PRACH transmission occasion in addition to, or alternative to, the number of preambles per SSB index per PRACH occasion (e.g., via ssb-perRACH-OccasionAndCB-PreamblesPerSSB).

The WTRU may receive one or more power ramping parameters. For example, the WTRU may be configured with an explicit indication for Type-2 ROs on power ramping step size (e.g., via powerRampingStep, msgA-PreamblePowerRampingStep, powerRampingStepHighPriority) and/or a maximum number of preamble transmissions (e.g., via preamble TransMax, preamble TransMax-Msg1-Repetition, msgA-TransMax, etc.).

The WTRU may be configured with an offset and/or differential indication on power ramping step size and/or maximum number of preamble transmissions. The WTRU may determine the corresponding parameters for Type-2 ROs, for example by using the configured and/or indicated offset and/or differential values based on the configured parameters for Type-1 ROs.

A WTRU may receive RACH repetition parameters. For example, the WTRU may be configured with explicit RSRP thresholds for one or more repetition numbers. In another example, the WTRU may be configured with an offset and/or differential indication on RSRP thresholds. The WTRU may (e.g., then) determine the RSRP thresholds for one or more repetition numbers for Type-2 ROs, for example by using the configured and/or indicated offset and/or differential values based on the configured RSRP thresholds for Type-1 ROs.

In another example, the Type-2 ROs may be determined to be frequency division multiplexed in frequency domain with the configured Type-1 ROs, for example as in FIG. 7. In another example, the WTRU may select an SSB (e.g., based on RSRP). The SSB may be from estimation and/or transmitted SSBs. The WTRU may determine the RO that is associated with the selected SSB. The WTRU may determine SSB-to-RO mapping in valid Type-1 and/or Type-2 ROs. The WTRU may send PRACH preamble based on the determined RO.

There may be RO selection for estimation SSB beams. A WTRU, for example an AIML-capable WTRU that has predicted RSRP of one or more of the estimation SSB beams based on measurements of transmitted SSBs, may determine whether to perform random access for the estimation SSB beams based on one or more conditions (e.g., during initial access, and/or BFR, etc.). The WTRU may receive a set of configurations on RACH configurations for transmitted and/or estimation SSB beams (e.g., within an SSB burst), for example via one or more of SIB1 and/or RRC). A configuration may include one or more of a set of transmitted SSBs, a set B of transmitted SSBs, a set of estimation SSBs (e.g., or set A), a set A transmission periodicity, an AIML model index, a first set of RACH occasion time/frequency configurations, and/or a second set of RACH occasion time/frequency configurations.

The set of transmitted SSBs may be via ssb-PositionsInBurst. The set B transmitted SSBs may be via ssb-PositionsInBurst-SetB. Set B may be the same as set of transmitted SSBs in SSB bursts with only including set B SSB beams. The set of estimation SSBs (e.g., or set A) may be via ssb-PositionsInBurst-SetA. The set A transmission periodicity may be explicitly and/or implicitly based on set B and SIB1 periodicity. The AIML model index(es) may be used for SSB predictions. The first set of RACH occasion (RO) time/frequency configurations may be associated with transmitted SSBs. The second set of RACH occasion (RO) time/frequency configurations may be associated with estimation SSBs. The second set of ROs may be an absolute set of configurations, and/or may be a relative set of time/frequency configurations (e.g., relative to the first set time/frequency configurations).

There may be a subset of allowed estimation SSBs, for example for PRACH transmission. The WTRU may receive an indication of a subset of SSBs from the configured set of estimation SSBs (e.g., via SIB1) (e.g., SSB-subset-Est), for example for which the WTRU is allowed to transmit PRACH preambles (e.g., in the associated ROs). Systems and methods may allow for traffic control and/or power saving, for example as gNB might not activate or use all UL beams.

A WTRU may receive and/or measure RSRP for one or more of the configured transmitted SSBs. Additionally, or alternatively, the WTRU may predict RSRP for one or more of the estimation SSBs. The WTRU may determine that the best beam among transmitted and estimation SSBs (e.g., with highest measured or predicted RSRP) is one of the estimation beams.

There may be one or more conditions on selecting an estimation SSB for RACH. A WTRU may determine whether the WTRU may select the predicted (e.g., best) estimation SSB for PRACH transmission, for example if the predicted (e.g., best) SSB in within the indicated subset of allowed estimation SSBs and/or based on one or more conditions (e.g., being satisfied). The one or more conditions may include an AIML model index, an AIML model performance accuracy, a set A periodicity, a number of transmitted SSBs, and/or one more prioritizations. The one or more prioritizations may be based on one or more of an RA triggered event, a time sensitive event (BFR, and/or SR, etc.), and/or other events (e.g., initial access, and/or PDCCH order, etc.). If the predicted (e.g., best) estimation SSB is within the indicated subset of allowed estimation SSBs and/or one or more conditions are satisfied for example, the WTRU may determine the RO associated with the predicted (e.g., best) estimation SSB.

There may be SSB-RO mapping. A WTRU may determine ROs (e.g., based on configured second set of RO configurations) and/or SSB-RO mapping for estimation SSBs, for example based on the configured estimation SSBs and/or the received indication on the subset of allowed estimation SSBs. The WTRU may determine SSB-RO mapping (e.g., only) for the ROs that are associated with the indicated subset of allowed estimation SSBs. If the predicted (e.g., best) estimation SSB is not within the indicated subset of allowed estimation SSBs and/or one or more conditions are not satisfied for example, the WTRU may (e.g., otherwise) select the best transmitted SSB (e.g., with highest measured RSRP) and/or determine the RO associated with the (e.g., best) transmitted SSB. The WTRU may transmit PRACH on the determined RO.

There may be a RACH configuration, for example for estimation SSB beams. A WTRU may receive one or more indications on (e.g., set of transmitted SSBs) set B (e.g., ssb-PositionsInBurst-SetB) and/or a set of estimation SSBs and/or set A SSB beams (ssb-PositionsInBurst-SetA), for example via SIB1.

The WTRU may receive one or more RACH configurations for a first set of ROs (e.g., Type-1 ROs) that, for example are associated with the transmitted SSBs and/or a second set of ROs (type-2 ROs) that, for example are associated with the estimation SSBs. There may be two separate sets of RACH configurations. The WTRU may receive a first and a second set of RO configurations associated with Type-1 and Type-2 ROs, respectively. The RACH configurations may include one or more of ROs' time and frequency config., SSB-to-RO mapping, power ramping parameters, and/or RACH repetition parameters, etc. The sets may be spread in time domain and/or frequency domain, for example as in FIG. 6. The two separate RACH configurations may have indicated two time division multiplexed set of ROs.

A WTRU may determine validity. If a Type-1 RO and a Type-2 RO overlap in time and/or frequency for example, the WTRU may determine the Type-1 RO to be valid and/or the Type-2 RO to be invalid. The WTRU may use a second (e.g., best) SSB and/or perform RACH procedure based on the selected second SSB, for example if the WTRU may not (e.g., be able to) send RACH based on the first selected estimation SSB that is associated with the overlapping Type-2 RO. The WTRU may indicate the first selected SSB to gNB via Msg3, and/or after connecting to the cell.

There may be a single set of RACH configurations. The WTRU may receive a (e.g., explicit) first set of RACH configurations associated with Type-1 ROs. The WTRU may (e.g., implicitly) determine the second set of RACH configurations associated with Type-2 ROs. The WTRU may receive one or more time and/or frequency offsets to determine the Type-2 ROs, for example based on the configured Type-1 ROs. For example, the WTRU may receive a second (e.g., associated with estimation SSBs) Msg1-FDM, msg1-FrequencyStart, and/or slot offset, etc. The WTRU may determine SSB-to-RO mapping in valid Type-1 and/or Type-2 ROs. The WTRU may select an SSB (e.g., based on RSRP). The SSB may be from estimation and/or transmitted SSBs. The WTRU may determine the RO that is associated with the selected SSB. The WTRU may send a PRACH preamble based on the determined RO.

1. A wireless transmit/receive unit (WTRU) comprising a processor, the processor configured to:
receive configuration information comprising an indication of a set of estimation synchronization signal blocks (SSBs) and a set of random access channel (RACH) occasions (ROs) configurations associated with the set of estimation SSBs;
receive an indication of allowed estimation SSBs, wherein the allowed estimation SSBs are a subset of the set of estimation SSBs that are allowed to be used for a RACH transmission;
determine a reference signal received power (RSRP) value for each estimation SSB of the set of estimation SSBs;
determine an estimation SSB out of the set of estimation SSBs for a RACH transmission based on the estimation SSB having the highest RSRP value of the set of estimation SSBs and a set of actually transmitted SSBs and based on the estimation SSB being part of the allowed estimation SSBs;
determine one or more ROs associated with the estimation SSB based on the ROs configurations associated with the set of estimation SSBs; and
transmit the RACH transmission on the one or more ROs associated with the estimation SSB.

2. The WTRU of claim 1, wherein the processor configured to determine the estimation SSB out of the set of estimation SSBs for the RACH transmission comprises the processor being configured to determine the estimation SSB out of the set of estimation SSBs based on one or more of an artificial intelligence machine learning (AIML) model index, an AIML model accuracy, a periodicity of the set of SSBs, a number of SSBs in the subset of SSBs, or a priority.

3. The WTRU of claim 2, wherein the processor configured to determine the estimation SSB out of the set of estimation SSBs based on the estimation SSB having the highest RSRP value of the set of estimation SSBs and the set of actually transmitted SSBs further comprises the processor being configured to select the estimation SSB of the set of estimation SSBs using an AIML model indicated by the AIML model index.

4. The WTRU of claim 1, wherein the processor is further configured to:
determine an RSRP value for each actually transmitted SSB of the set of actually transmitted SSBs; and
wherein the processor configured to receive the configuration information comprises the processor being configured to receive an indication of a set of actually transmitted SSBs and a set of ROs configurations associated with the set of actually transmitted SSBs.

5. The WTRU of claim 4, wherein the processor configured to determine the RSRP value for each estimation SSB of the set of estimation SSBs comprises the processor being configured to determine the RSRP value for each estimation SSB of the set of estimation SSBs based on one or more RSRP values for one or more of the actually transmitted SSBs of the set of actually transmitted SSBs.

6. The WTRU of claim 4, wherein the processor configured to determine the actually transmitted SSB out of the set of actually transmitted SSBs for the RACH transmission comprises the processor being configured to determine the actually transmitted SSB out of the set of actually transmitted SSBs for the RACH transmission when the actually transmitted SSB has the highest RSRP value of the SSBs of the set of estimation SSBs and of the SSBs of the set of actually transmitted SSBs.

7. The WTRU of claim 4, wherein the processor configured to determine the actually transmitted SSB out of the set of actually transmitted SSBs for the RACH transmission comprises the processor being configured to determine the actually transmitted SSB out of the set of actually transmitted SSBs for the RACH transmission when an estimation SSB of the set of estimation SSBs has the highest RSRP value of the set of estimation SSBs and of the set of actually transmitted SSBs and the estimation SSB is not part of the allowed estimation SSBs.

8. The WTRU of claim 1, wherein the processor configured to determine the estimation SSB out of the set of estimation SSBs for the RACH transmission comprises the processor being configured to determine the estimation SSB out of the set of estimation SSBs for the RACH transmission based on a comparison between a RSRP value of an actually transmitted SSB of the set of actually transmitted SSBs and a RSRP value of an estimation SSB of the set of estimation SSBs being less than a threshold.

9. The WTRU of claim 1, wherein the processor configured to determine the estimation SSB out of the set of estimation SSBs for the RACH transmission comprises the processor being configured to determine the estimation SSB out of the set of estimation SSBs for the RACH transmission based on a periodicity of the estimation SSB.

10. The WTRU of claim 1, wherein the processor configured to determine the estimation SSB out of the set of estimation SSBs for the RACH transmission comprises the processor being configured to determine the estimation SSB out of the set of estimation SSBs for the RACH transmission based on a number of actually transmitted SSBs in the set of actually transmitted SSBs being less than a threshold.

11. A method implemented by a wireless transmit/receive unit (WTRU), the method comprising:
receiving configuration information comprising an indication of a set of estimation synchronization signal blocks (SSBs) and a set of random access channel (RACH) occasions (ROs) configurations associated with the set of estimation SSBs;
receiving an indication of allowed estimation SSBs, wherein the allowed estimation SSBs are a subset of the set of estimation SSBs that are allowed to be used for a RACH transmission;
determining a reference signal received power (RSRP) value for each estimation SSB of the set of estimation SSBs;
determining an estimation SSB out of the set of estimation SSBs for a RACH transmission based on the estimation SSB having the highest RSRP value of the set of estimation SSBs and a set of actually transmitted SSBs and based on the estimation SSB being part of the allowed estimation SSBs;
determining one or more ROs associated with the estimation SSB based on the ROs configurations associated with the set of estimation SSBs; and
transmitting the RACH transmission on the one or more ROs associated with the estimation SSB.

12. The method of claim 11, wherein determining the estimation SSB out of the set of estimation SSBs for the RACH transmission comprises determining the estimation SSB out of the set of estimation SSBs based on one or more of an artificial intelligence machine learning (AIML) model index, an AIML model accuracy, a periodicity of the set of SSBs, a number of SSBs in the subset of SSBs, or a priority.

13. The method of claim 11, further comprising:
determining an RSRP value for each actually transmitted SSB of the set of actually transmitted SSBs; and
wherein the configuration information further comprises an indication of a set of actually transmitted SSBs and a set of ROs configurations associated with the set of actually transmitted SSBs.

14. The method of claim 13, wherein determining the RSRP value for each estimation SSB of the set of estimation SSBs comprises determining the RSRP value for each estimation SSB of the set of estimation SSBs based on one or more RSRP values for one or more of the actually transmitted SSBs of the set of actually transmitted SSBs.

15. The method of claim 11, further comprising:
determining the estimation SSB out of the set of estimation SSBs for the RACH transmission based on a comparison between a RSRP value of an actually transmitted SSB of the set of actually transmitted SSBs and a RSRP value of an estimation SSB of the set of estimation SSBs being less than a threshold.

16. The method of claim 11, further comprising:
determining the estimation SSB out of the set of estimation SSBs for the RACH transmission based on a periodicity of the estimation SSB.

17. The method of claim 11, wherein determining the one or more ROs associated with the estimation SSB further comprises determining the one or more ROs associated with the estimation SSB based on the subset of the set of estimation SSBs that are allowed to be used for the RACH transmission.

18. A method implemented by a wireless transmit/receive unit (WTRU), the method comprising:
receiving configuration information comprising an indication of a set of estimation synchronization signal blocks (SSBs), a set of random access channel (RACH) occasions (ROs) configurations associated with the set of estimation SSBs, an indication of a set of actually transmitted SSBs, and a set of ROs configurations associated with the set of actually transmitted SSBs;
receiving an indication of allowed estimation SSBs, wherein the allowed estimation SSBs are a subset of the set of estimation SSBs that are allowed to be used for a RACH transmission;
determining an RSRP value for each actually transmitted SSB of the set of actually transmitted SSBs;
determining a reference signal received power (RSRP) value for each estimation SSB of the set of estimation SSBs based on the RSRP values for each actually transmitted SSB of the set of actually transmitted SSBs;
determining an SSB out of the set of estimation SSBs or the set of actually transmitted SSBs for a RACH transmission, wherein determining the SSB out of the set of estimation SSBs or the set of actually transmitted SSBs for the RACH transmission comprises:
determining the SSB to be an SSB out of the set of estimation SSBs when the estimation SSB has the highest RSRP value of the set of estimation SSBs and of the set of actually transmitted SSBs and when the estimation SSB is part of the allowed estimation SSBs;
determining the SSB to be an SSB out of the set of actually transmitted SSBs when the actually transmitted SSB has the highest RSRP value of the set of estimation SSBs; or
determining the SSB to be an SSB out of the set of actually transmitted SSBs when the estimation SSB has the highest RSRP value of the set of estimation SSBs and of the set of actually transmitted SSBs and the estimation SSB is not part of the allowed estimation SSBs;
determining one or more ROs associated with the SSB based on the ROs configurations associated with the set of estimation SSBs or the ROs configurations associated with the set of actually transmitted SSBs; and
transmitting the RACH transmission on the one or more ROs associated with the SSB.

19. The method of claim 18, wherein determining the SSB out of the set of estimation SSBs or the set of actually transmitted SSBs further comprises determining the SSB out of the set of estimation SSBs or the set of actually transmitted SSBs based on one or more of an artificial intelligence machine learning (AIML) model index, an AIML model accuracy, a periodicity of the set of SSBs, a number of SSBs in the subset of SSBs, or a priority.

20. The method of claim 18, wherein determining the SSB out of the set of estimation SSBs or the set of actually transmitted SSBs comprises determining the SSB out of the set of estimation SSBs or the set of actually transmitted SSBs based on a comparison between a RSRP value of an actually transmitted SSB of the set of actually transmitted SSBs and a RSRP value of an estimation SSB of the set of estimation SSBs being less than a threshold.
